(19) United States
(12) Patent Application Publication
(10) Pub. No.: US 2006/0096192 A1
(43) Pub. Date: May 11, 2006

(54) Building construction components

(76) Inventor: Larry Randall Daudet, Chesterton, IN (US)

Correspondence Address: KIRKPATRICK & LOCKHART NICHOLSON GRAHAM LLP, 535 SMITHFIELD STREET, PITTSBURGH, PA, 15222, US

(21) Appl. No.: 11/139,183

(22) Filed: May 27, 2005

Related U.S. Application Data
(63) Continuation-in-part of application No. 11/093,804, filed on Mar. 30, 2005.
Application No. 11/093,804 is a continuation-in-part of application No. 10/981,868, filed on Nov. 5, 2004.

(51) Int. Cl. E06B 1/04

(52) U.S. Cl. 52/204.1

(57) ABSTRACT

Header and jamb stud arrangements, truss assemblies, and support posts are disclosed. The assemblies employ a stud that has a web, a pair of flanges protruding from the web, a leg protruding from each flange and a return formed on the end of each leg.

### CROSS-REFERENCE TO RELATED APPLICATIONS

This application is a continuation-in-part application of U.S. patent application Ser. No. 11/093,804, entitled Building Construction Components, filed Mar. 30, 2005 which is a continuation-in-part of U.S. patent application Ser. No. 10/981,868, entitled Building Construction Components, filed Nov. 5, 2004, the disclosures of which are herein incorporated by reference.

### BACKGROUND OF THE INVENTION

1. Field of the Invention

The invention relates to building construction components and, more particularly, to building construction components fabricated from metal such as headers, sills, trusses, girders and support posts.

2. Description of the Invention Background

Traditionally, the material of choice for new residential and commercial building framing construction has been wood. However, over the years, the rising costs of lumber and labor required to install wood framing components have placed the dream of owning a newly constructed home out of the economic reach of many families. Likewise, such increasing costs have contributed to the slowing of the development and advancement of urban renewal plans in many cities. Other problems such as the susceptibility to fire and insect damage, rotting, etc. are commonly associated with wood building products.

In view of the foregoing problems and shortcomings of wood construction, steel is rapidly gaining acceptance among homebuilders and homeowners alike due to its cost effectiveness, dimensional stability, noncombustibility, insect resistance, durability, high strength-to-weight ratio and recycleability. These advantages have long been recognized by the commercial construction industry wherein steel has been the material of choice for several decades.

Regardless of whether a building comprises a multistory commercial structure or a single story residence, C-shaped metal studs and tracks are commonly used in their construction. FIG. 1 illustrates a conventional C-shaped metal stud 10 that has a web 12 and a pair of flanges 14. A lip 16 is also formed on the end of each flange 14 to further strengthen the stud. Such studs 10 are commonly fabricated from cold-formed steel utilizing conventional rollforming techniques. Similarly, the conventional tracks 20 that are employed by the building trades each have a web 22 and a pair of flanges 24. The tracks 20 are similar in construction as the C-shaped studs, but lack the lack the lips that are commonly formed on the ends of the stud flanges. See FIG. 2.

In most construction applications, walls are constructed by attaching a series of C-shaped studs between a top track and a bottom track. The bottom track is usually attached to the floor structure by screws or other fasteners and the top track is usually attached to the ceiling joists. The ends of the studs are inserted into the top and bottom tracks and are attached thereto by screws, welds, etc. After the wall frame is constructed, then the desired wallboard material is attached to the flanges of the studs and tracks utilizing screws or other fasteners to complete the wall assembly.

In those walls that require door and/or window openings to be framed therein, a header is constructed to transfer loads occurring above the opening to the vertically extending studs adjacent the opening. The studs that define the vertical boundaries of the opening are often referred to as the “jamb” studs. FIGS. 3-5 illustrate one prior header and jamb stud arrangement that is formed utilizing conventional C-shaped studs and tracks. As can be seen in FIGS. 3 and 4, the header 30 is formed by attaching a first C-shaped stud 32 to a track 40 such that the flanges 36 of the stud 32 are received between the flanges 42 of the track 40. A second upwardly facing piece of track 46 is then attached to the web 34 of the first stud 32. Such header 30 is commonly fabricated by attaching these components together with fasteners such as screws 49 or the like. The use of such screws, however, creates undesirable buildups which can lead to drywall finishing problems. In the alternative, the components may be welded together which adds to assembly time and expense.

Likewise, the jamb studs 50 are each commonly formed by attaching a C-shaped stud 52 to another piece of track 60 such that the flanges 56 of the stud 52 are received between the flanges 64 of the track 60 and then attaching the web 72 of another stud 70 to the web 64 of the track 60. These components are also commonly coupled together with screws 49 which can lead to drywall finishing problems. In the alternative, they may be welded together to form the jamb stud 50. Such assembly approach requires additional skilled labor. These combinations of components have been found to provide the jamb stud with a sufficient amount of strength to receive the loads from the header without failing or buckling.

To complete the header assembly, the header 30 is then attached to each jamb stud 50 by corresponding L-shaped clips 80. The clips 80 are welded or screwed to each jamb stud 50. In addition, sections of studs 82 are attached between the track 60 and the section of upper track (not shown) to which the upper ends of the jamb studs 50 are attached. Such stud segments 82 are often referred to in the industry as “cripple studs” and further transfer loads from the upper structures to the header.

FIG. 6 illustrates a prior truss chord 90 that is fabricated utilizing conventional C-shaped studs. By way of background, trusses are used to form the support frame for a roof or, in some applications, are used to form the support for an upper floor. The upper and lower portions of the truss are known as the “chords” and the members that extend between the chords are called “webs”. As can be seen in FIG. 6, a typical method employed to form a truss chord 90 is to weld two C-shaped studs 92 together as shown. The truss webs are formed from other pieces of C-shaped studs 94 that are fastened to the chord 90 by screws, bolts etc. This arrangement, however, is labor intensive because studs have to be welded together to form the necessary chords.

Conventional C-shaped studs and tracks are also used to form support posts for supporting loads from the structures located above the posts. FIG. 7 illustrates a prior method of constructing a support post. As can be seen in that Figure, a total of 3 C-shaped studs 102 and two tracks 104 are employed. The studs 102 and tracks 104 may be connected together by a collection of screws or by welding. Both fastening methods, however, are time consuming and attribute to higher labor costs associated with their fabrication.

Floors are also constructed utilizing components that are somewhat identical to C-shaped studs and tracks utilized to form the wall frames for the structure. However, the tracks and C-shaped members used to form the floor structure can be larger than those like-shaped components used to form wall structures. The floor of a structure is commonly formed from a series of C-shaped members that span the distance between support structures or support walls. These C-shaped members are commonly referred to as floor joists. The ends of the joists are coupled to tracks referred to as joist rims that are either supported on a wall or other structure by one of their flanges or have their webs attached to the wall or structure. The joists are commonly attached to the joist rims by conventional L-shaped clips or by tabs that are integrally formed in the web of the joist rim.

In those instances wherein the span is too long or loading conditions require it, beams known as girders are employed. The girders serve as points of attachments for the ends of adjacent floor joists as shown in FIG. 8. In the past, many floor girders 110 were fabricated utilizing a conventional stud 112 nested in a conventional track 118. The flanges of the track 118 and stud 112 were attached together utilizing screws 119 or welds. The floor joists 120 were then attached to the girder 110 by means of L-shaped clips 122 and screws. Such approach required extra labor to assembly the girders. In addition, when screws are used to assemble the girder, the screws cause the flooring material to be raised up or bulge in the area around each screw head.

FIG. 8A illustrates a prior method of constructing a load bearing header arrangement. As can be seen in that Figure, the header 130 was formed from two conventional studs or C-shaped members 140 that were retained in spaced-apart relationship relative to each other between a piece of upper track 150 and a piece of lower track 160. The pieces are held together by a collection of screws 162 or by welding. Both fastening methods, however, are undesirably time consuming.

Thus, as can be appreciated from the forgoing discussion, a variety of different components utilized in constructing residential and commercial buildings from steel are fabricated from conventional C-shaped studs and tracks. While the use of such components affords a host of advantages over the use of wood beams and the like, the added labor and materials required to fabricate such components undesirably lead to increased construction costs.

### SUMMARY

In accordance with one embodiment of the present invention, there is provided a header and jamb stud arrangement that includes a jamb stud assembly that comprises a jamb stud that has a substantially planar jamb stud web and first and second jamb stud flanges that protrude from the substantially planar jamb stud web. A first jamb stud leg protrudes from the first jamb stud flange and is substantially parallel to the substantially planar jamb stud web. A second jamb stud leg protrudes from the second jamb stud flange and is substantially parallel to the substantially planar jamb stud web. A first jamb stud return is formed on an end of the first jamb stud leg and a second jamb stud return is formed on an end of the second jamb stud leg. The header and jamb stud arrangement further includes another jamb stud that has the attributes of the above-mentioned jamb stud. The web of the another jamb stud is adjacent to the substantially planar jamb stud web of the first jamb stud. A third jamb stud is supported in spaced-apart relationship with respect to the jamb stud assembly. A first C-shaped connector is attached to the jamb stud assembly and has a pair of spaced first flanges that define a first header-receiving area therebetween. A C-shaped track is attached to a portion of the jamb stud assembly that is located beneath the first C-shaped connector. A second C-shaped connector is attached to the third jamb stud and has a pair of spaced second flanges that define a second header-receiving area therebetween. A first end of at least one header is received in the first header-receiving area of the first C-shaped connector. A second end of the header is received in the second header-receiving area of the second C-shaped connector. The header spans between the jamb stud assembly and the third jamb stud to define an upper boundary of an opening therebetween.

Another embodiment of the present invention comprises a header and jamb stud arrangement that includes a first jamb stud and a second jamb stud supported in spaced-apart relationship with respect to the first jamb stud. A first C-shaped connector is attached to the jamb stud assembly. The first C-shaped connector has a pair of spaced first flanges that define a first header-receiving area therebetween. A second C-shaped connector is attached to the third jamb stud and has a pair of spaced second flanges that define a second header-receiving area therebetween. A first end of a first header is received in the first header-receiving area of the first C-shaped connector. A second end of the first header is received in the second header-receiving area of the second C-shaped connector and spans between the first and second jamb studs. A second header is adjacent to the first header and has one end thereof received in the first header-receiving area of the first C-shaped connector and another end thereof is received in the second header-receiving area of the second C-shaped connector. The second header spans between the first and second jamb studs.

Another embodiment of the present invention comprises a truss assembly that includes a first truss chord that has a substantially planar first truss cord web and a first truss chord flange that protrudes from the substantially planar first truss chord web. A second truss chord flange protrudes from the substantially planar first truss chord web and is spaced from the first truss chord flange. A first truss chord leg protrudes from the first truss chord flange and is substantially parallel to the substantially planar first truss chord web. A second truss chord leg protrudes from the second truss chord flange and is substantially parallel to the substantially planar first truss chord web and is substantially coplanar with the first truss chord leg. A first truss chord return is on an end of the first truss chord leg and a second truss chord return is on an end of the second truss chord leg. The truss assembly further includes another truss chord that has another substantially planar truss chord web. Another first truss chord flange protrudes from the another substantially planar truss chord web. Another second truss chord flange protrudes from the another substantially planar truss chord web and is spaced from the another first truss chord flange. Another first truss chord leg protrudes from the another first truss chord flange and is substantially parallel to the another substantially planar truss chord web. Another second truss chord leg protrudes from the another second truss chord flange and is substantially parallel to the another substantially planar truss chord web and further is substantially coplanar with the another first truss chord leg. Another first truss chord return is provided on another end of the another first truss chord leg. Another second truss chord return is provided on another end of the another second truss chord leg. The another truss chord stud is retained in abutting contact with the first truss chord to form a truss chord assembly. At least one web assembly is attached to the truss chord assembly.

Another embodiment of the present invention comprises a truss that is supported between two support structures. One embodiment of the truss comprises at least one first truss stud that extends between the support structures and is received thereon. The first truss stud includes a substantially planar first truss stud web and a first truss stud flange that protrudes from the substantially planar first truss stud web. A second truss stud flange protrudes from the substantially planar first truss stud web and is spaced from the first truss stud flange. A first truss stud leg protrudes from the first truss stud flange and is substantially parallel to the substantially planar first truss stud web. A second truss stud leg protrudes from the second truss stud flange and is substantially parallel to the substantially planar first truss stud web and is substantially coplanar with the first truss stud leg. A first truss stud return is on an end of the first truss stud leg and a second truss stud return is on an end of the second truss stud leg. At least two other chord studs form a peak of the truss and are coupled to the first truss stud. Each chord stud includes another substantially planar chord web and a first chord flange that protrudes from the substantially planar chord web. A second chord flange protrudes from the substantially planar chord web and is spaced from the first chord flange. A first chord leg protrudes from the first chord flange and is substantially parallel to the substantially planar chord web. A second chord leg protrudes from the second chord flange and is substantially parallel to the substantially planar chord web and is substantially coplanar with the first chord leg. A first chord return is on an end of the first chord leg and a second chord return is on an end of the second chord.

Yet another embodiment of the present invention comprises a header and jamb stud arrangement that includes a header that has two ends and a height. A jamb stud corresponds to each end of the header wherein at least one of the jamb studs comprises a substantially planar jamb stud web. A first jamb stud flange protrudes from the substantially planar jamb stud web. A second jamb stud flange protrudes from the substantially planar jamb stud web and is spaced from the first jamb stud flange. A first jamb stud leg protrudes from the first jamb stud flange and is substantially parallel to the substantially planar jamb stud web. A second jamb stud leg protrudes from the second jamb stud flange and is substantially parallel to the substantially planar jamb stud web. A first jamb stud return is on an end of the first jamb stud leg and a second jamb stud return is on an end of the second jamb stud leg. A bearing plate is on an upper end of at least one of the jamb studs for receiving an end of the header thereon. A stud is attached to the jamb stud that supports the bearing plate and extends beyond the bearing plate a distance that substantially corresponds to the height of the header.

Another embodiment of the present invention comprises a jamb stud arrangement for attachment to a structure and a track that is attached to the structure. The track has a web and a pair of flanges. The jamb stud includes a substantially planar jamb stud web and a first jamb stud flange that protrudes from the substantially planar jamb stud web. A second jamb stud flange protrudes from the substantially planar jamb stud web and is spaced from the first jamb stud flange. A first jamb stud leg protrudes from the first jamb stud flange and is substantially parallel to the substantially planar jamb stud web. A second jamb stud leg protrudes from the second jamb stud flange and is substantially parallel to the substantially planar jamb stud web. A first jamb stud return is on an end of the first jamb stud leg and a second jamb stud return is on an end of the second jamb stud leg. At least one L-shaped connector that has one leg attached to the jamb stud and the other leg attached to the track is included to affix the jamb stud to the track.

Another embodiment of the present invention comprises a jamb stud arrangement for attachment to a track that is attached to a structure. The track has a web and a pair of flanges. This arrangement also includes a jamb stud that has a substantially planar jamb stud web and a first jamb stud flange that protrudes from the substantially planar jamb stud web. A second jamb stud flange protrudes from the substantially planar jamb stud web and is spaced from the first jam stud flange. A first jamb stud leg protrudes from the first jamb stud flange and is substantially parallel to the substantially planar jamb stud web. A second jamb stud leg protrudes from the second jamb stud flange and is substantially parallel to the substantially planar jamb stud web. A first jamb stud return is on an end of the first jamb stud leg and a second jamb stud return on an end of the second jamb stud leg. At least one hold-down is attached to the jamb stud and the track.

Another embodiment of the present invention comprises a support post that includes a post stud that has a substantially planar post stud web and a first post stud flange that protrudes from the substantially planar post stud web. A second post stud flange protrudes from the substantially planar post stud web and is spaced from the first post stud flange. A first post stud leg protrudes from the first post stud flange and is substantially parallel to the substantially planar post stud web. A second post stud leg protrudes from the second post stud flange and is substantially parallel to the substantially planar post stud web. A first post stud return is on an end of the first post stud leg and a second post stud return is on an end of the second post stud leg. The support post further includes another post stud that has another substantially planar post stud web. The another substantially planar post stud web is attached to the substantially planar post stud web of the post stud. Another first post stud flange protrudes from the another substantially planar post stud web. Another second post stud flange protrudes from the another substantially planar post stud web and is spaced from the another first post stud flange. Another first post stud leg protrudes from the another first post stud flange and is substantially parallel to the another substantially planar post stud web. Another second post stud leg protrudes from the another second post stud flange and is substantially parallel to the another substantially planar post stud web. Another first post stud return is formed on an end of the another first post stud leg. Another second post stud return is formed on an end of the another second post stud leg.

### BRIEF DESCRIPTION OF THE DRAWINGS

In the accompanying Figures, there are shown present embodiments of the invention wherein like reference numerals are employed to designate like parts and wherein:

FIG. 1 is a perspective view of a prior art C-shaped stud;

FIG. 2 is a perspective view of a prior art track;

FIG. 3 is a partial perspective view of a prior header and jamb stud arrangement;

FIG. 4 is a partial end view of the prior header arrangement depicted in FIG. 3;

FIG. 5 is a partial end of the prior jamb stud arrangement depicted in FIG. 3;

FIG. 6 is a partial perspective view of a prior truss chord assembly;

FIG. 7 is a partial perspective view of a prior art post arrangement;

FIG. 8 is a partial perspective view of a prior floor girder and floor joist arrangement;

FIG. 8A is a perspective view of a portion of a prior header assembly;

FIG. 9 is an elevational view of a wall frame that employs a header embodiment, a sill embodiment and a jamb stud embodiment of the present invention;

FIG. 9A is an elevational view of another wall frame that employs other header and jamb stud arrangements of the present invention;

FIG. 9B is an elevational view of another wall frame that employs other header and jamb stud arrangements of the present invention;

FIG. 9C is an elevational view of another wall frame that employs other header and jamb stud arrangements of the present invention;

FIG. 10 is an end view of a stud embodiment of the present invention;

FIG. 11 is a perspective view of a portion of a header and jamb stud embodiment of the present invention;

FIG. 11A is a perspective view of the header and jamb stud embodiment depicted in FIG. 11 with a conventional stud attached to the jamb stud;

FIG. 11B is a perspective view of a portion of another header and jamb stud embodiment of the present invention;

FIG. 11C is a perspective view of a portion of another header and jamb stud embodiment of the present invention;

FIG. 11D is a partial front elevational view of the header and jamb stud assembly of FIG. 11C;

FIG. 12 is a partial cross-section view of the header and jamb stud embodiment of the FIG. 11 taken along line 12-12 in FIG. 11;

FIG. 13 is a perspective view of one embodiment of an attachment clip of the present invention;

FIG. 14 is a partial cross-sectional view of the sill and jamb stud embodiment of FIG. 9 taken along line 14-14 in FIG. 9;

FIG. 15 is a partial perspective view of another header and jamb stud embodiment of the present invention;

FIG. 16 is a perspective view of another attachment clip of the present invention;

FIG. 17 is a perspective view of a portion of a truss chord embodiment of the present invention;

FIG. 18 is a perspective view of a portion of a truss embodiment of the present invention;

FIG. 18A is an elevational view of a truss that employs various truss-related embodiments of the present invention;

FIG. 18B is a perspective view of a portion of the truss peak of the truss depicted in FIG. 18A;

FIG. 18C is a perspective view of a portion of one of the truss heal details of the truss depicted in FIG. 18A;

FIG. 18D is an elevational view of another truss that employs a truss chord and web arrangement of one embodiment of the present invention;

FIG. 18E is a perspective view of a portion of a chord and web arrangement of one embodiment of the present invention employed in the truss of FIG. 18D;

FIG. 19 is a perspective view of a portion of a support post of the present invention;

FIG. 19A is a perspective view of a portion of another support post of the present invention;

FIG. 19B is a perspective view of a portion of another support post arrangement of the present invention;

FIG. 20 is a portion of a cross-sectional view of the support post embodiment of FIG. 19 taken along line 20-20 in FIG. 19;

FIG. 21 is a perspective view of a portion of a floor girder embodiment of the present invention;

FIG. 22 is an end view of another stud embodiment of the present invention;

FIG. 23 is a perspective view of a portion of the stud of FIG. 22;

FIG. 24 is a perspective view of a portion of other stud embodiments of the present invention;

FIG. 25 is a perspective view of a portion of a conventional header assembly attached to a portion of a conventional jamb stud assembly utilizing a pair of connection plates of one embodiment of the present invention;

FIG. 26 is a perspective view of one embodiment of a connection plate of the present invention;

FIG. 27 is a plan view of a squared-shaped hole through the connection plate depicted in FIG. 26;

FIG. 28 is a plan view of a triangular-shaped hole through the connector plate of FIG. 26;

FIG. 29 is a cross-section al view of the header assembly and jamb stud arrangement depicted in FIG. 25 taken along lines 29-29 in FIG. 25;

FIG. 30 is a perspective view of a portion of one embodiment of a header assembly of the present invention attached to a portion of a conventional jamb stud assembly utilizing a pair of connection plates of one embodiment of the present invention;

FIG. 30A is another perspective view of the header assembly arrangement of FIG. 30 attached to a header track and cripple studs;

FIG. 31 is a cross-sectional view of the header assembly depicted in FIG. 30 taken along line 31-31 in FIG. 30;

FIG. 31A is a cross-sectional view of the header assembly of FIG. 30A taken along line 31A-31A in FIG. 30A;

FIG. 32 is a perspective view of a portion of one embodiment of another header assembly of the present invention attached to a portion of a conventional jamb stud assembly utilizing a pair of connection plates of one embodiment of the present invention;

FIG. 33 is a cross-sectional view of the header assembly depicted in FIG. 32 taken along line 33-33 in FIG. 32;

FIG. 34 is a perspective view of a portion of one embodiment of another header assembly of the present invention attached to a portion of a conventional jamb stud assembly utilizing a pair of connection plates of one embodiment of the present invention;

FIG. 35 is a cross-sectional view of the header assembly depicted in FIG. 34 taken along line 35-35 in FIG. 34;

FIG. 36 is a perspective view of a portion of one embodiment of a header assembly of the present invention attached to a portion of a jamb stud of the present invention utilizing a pair of connection plates of one embodiment of the present invention;

FIG. 37 is a cross-sectional view of the header assembly depicted in FIG. 36 taken along line 37-37 in FIG. 36;

FIG. 38 is a perspective view of a portion of one embodiment of another header assembly of the present invention attached to a portion of a jamb stud of the present invention utilizing a pair of connection plates of one embodiment of the present invention;

FIG. 39 is a cross-sectional view of the header assembly depicted in FIG. 38 taken along line 39-39 in FIG. 38;

FIG. 40 is a perspective view of a portion of one embodiment of another header assembly of the present invention attached to a portion of a jamb stud of the present invention utilizing a pair of connection plates of one embodiment of the present invention;

FIG. 41 is a cross-sectional view of the header assembly depicted in FIG. 40 taken along line 41-41 in FIG. 40;

FIG. 42 is a perspective view of a portion of a load bearing jack post assembly and header arrangement of one embodiment of the present invention;

FIG. 43 is a front elevational view of the portion of the load bearing jack post assembly and header arrangement of FIG. 42;

FIG. 44 is a perspective view of a method for attaching a jamb stud embodiment of the present invention to a portion of a bottom track;

FIG. 45 is a perspective view of a jamb stud embodiment of the present invention attached to a portion of an upper track that is attached to a structure;

FIG. 46 is a perspective view of one embodiment of a slide bracket for fastening a jamb stud of the present invention to an upper track;

FIG. 47 is an elevational view of the jamb stud and bracket of FIG. 46;

FIG. 48 is a perspective view of a stud of the present invention slidably affixed to an I beam;

FIG. 49 is a perspective view of one embodiment of a bracket for slidably attaching a stud of the present invention to an I beam;

FIG. 50 is a top view of the stud and I beam connection depicted in FIG. 48;

FIG. 51 is a perspective view of a portion of a stud of the present invention slidably attached to an I beam;

FIG. 52 is a top view of the stud and I beam connection depicted in FIG. 51;

FIG. 53 is a perspective view of a shearwall post embodiment of the present invention attached to a structure;

FIG. 54 is a perspective view of another shearwall post embodiment of the present invention attached to a structure;

FIG. 55 is a perspective view of a stud of the present invention attached to a structure;

FIG. 56 is a perspective view of one embodiment of a bracket for attaching a stud of the present invention to a structure;

FIG. 57 is another perspective view of a stud of the present invention attached to a structure; and

FIG. 58 is another perspective view of a stud of the present invention attached to a structure.

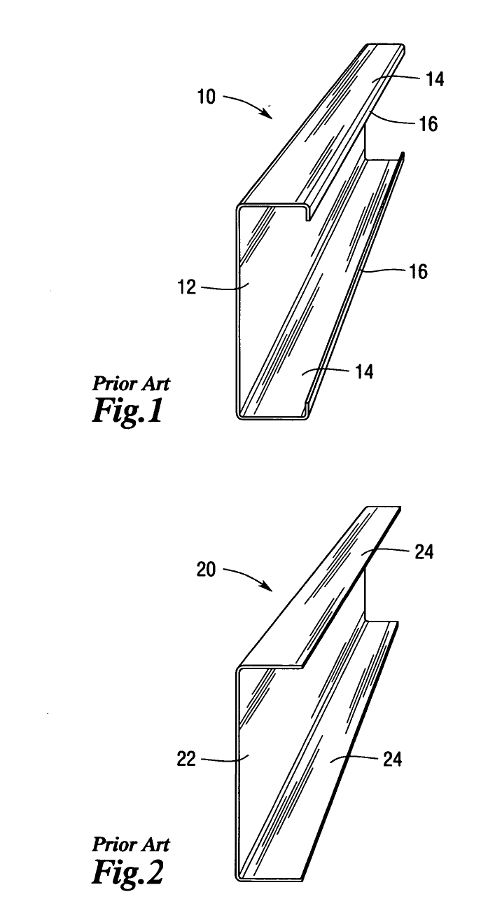

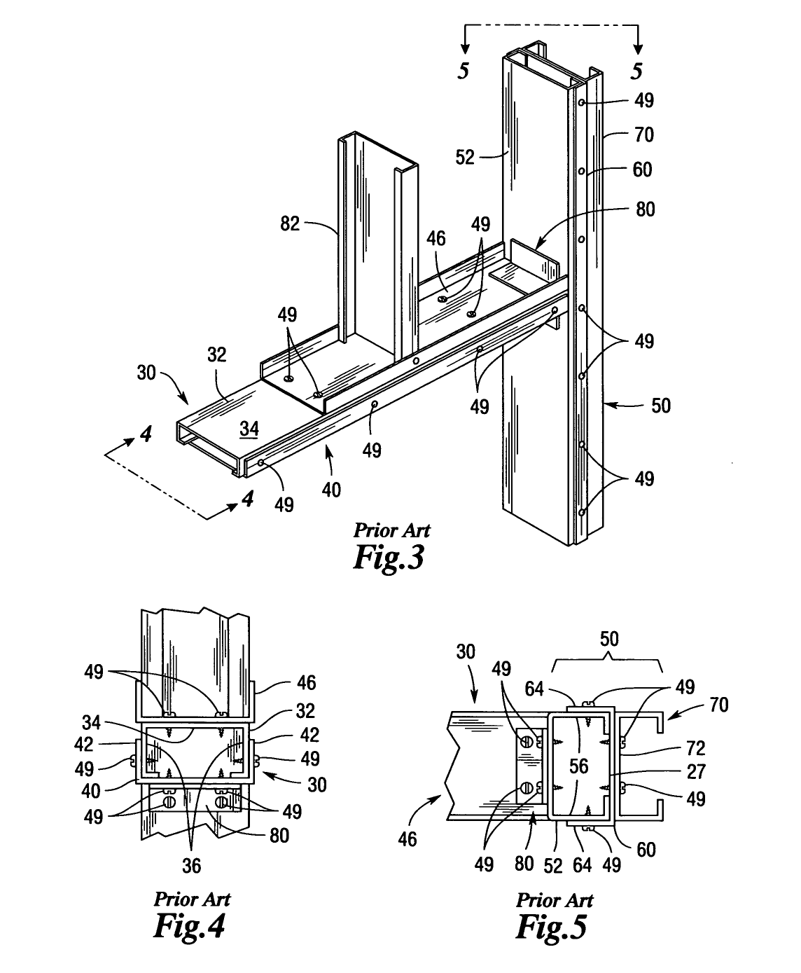

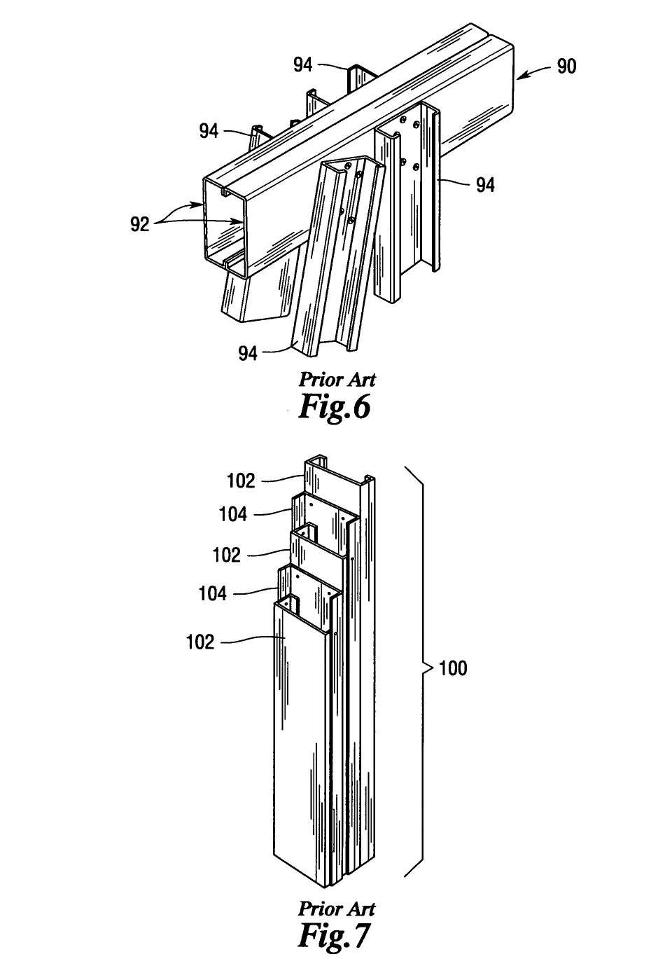

### DETAILED DESCRIPTION OF THE INVENTION

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

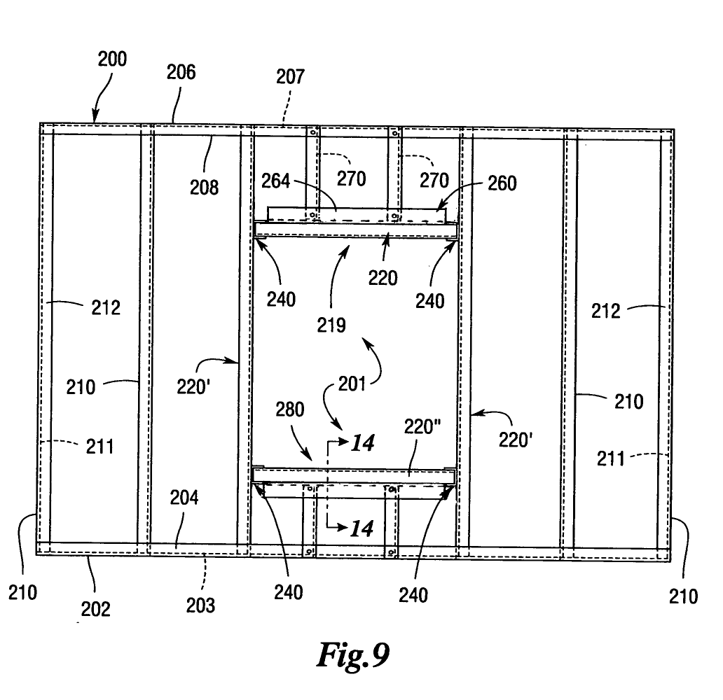

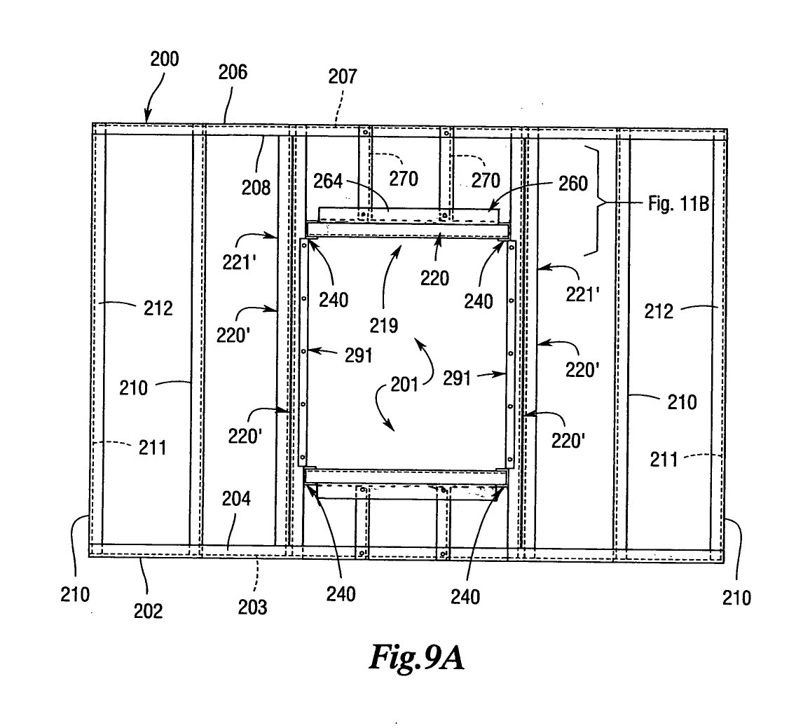

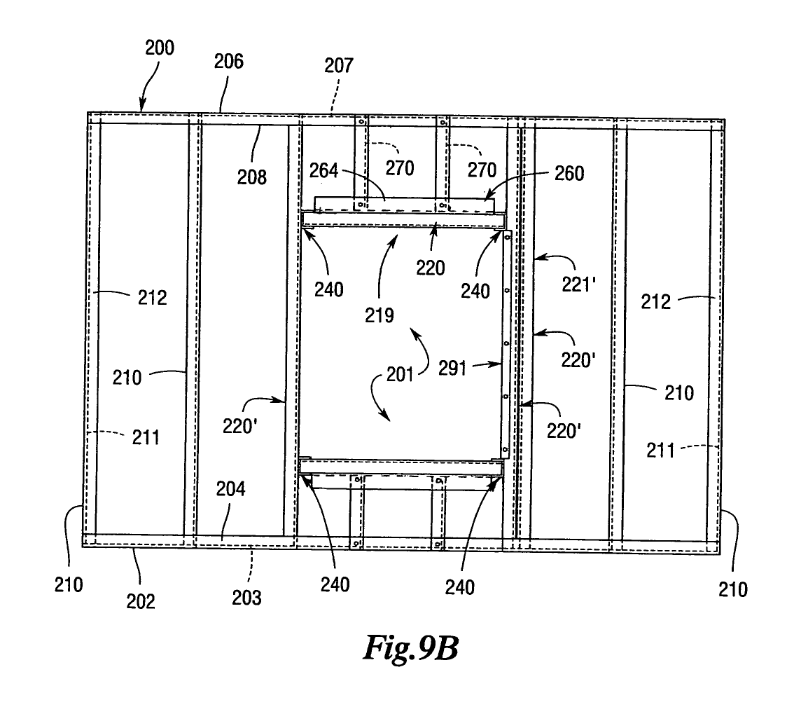

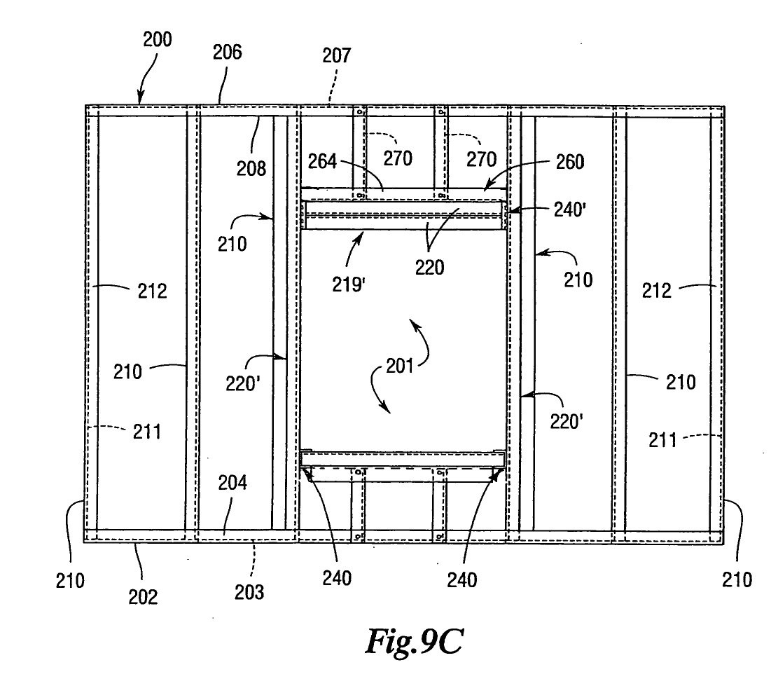

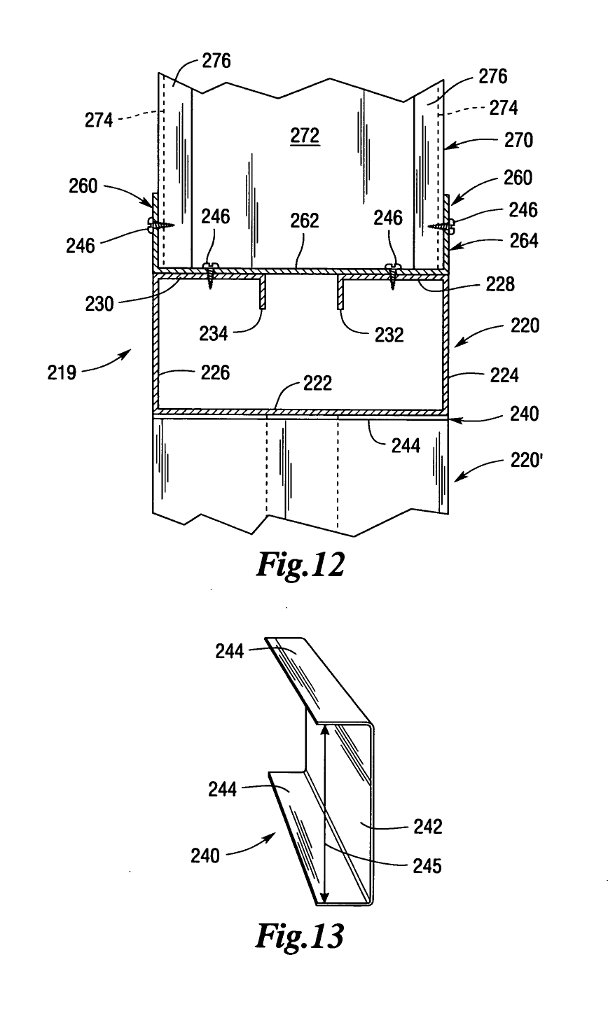

Referring now to the drawings for the purposes of illustrating the present embodiments of the invention only and not for the purposes of limiting the same, FIGS. 9, 11 and 12 illustrate one embodiment of a header assembly 219 of the present invention utilized to form a window opening 201 in a wall frame structure 200. As can be seen in FIG. 9, the wall frame structure 200 may be fabricated from a lower track 202 and an upper track 206. The lower track has a web 203 and a pair of upstanding flanges 204. Similarly, the upper track 206 has a web 207 and a pair of flanges 208. A plurality of studs 210 are connected between the lower track 202 and the upper track 206 utilizing screws or other suitable fastening methods. The studs 210 are conventional in nature and have a web 211, a pair of flanges 212 and a lip formed on the end of each flange 212.

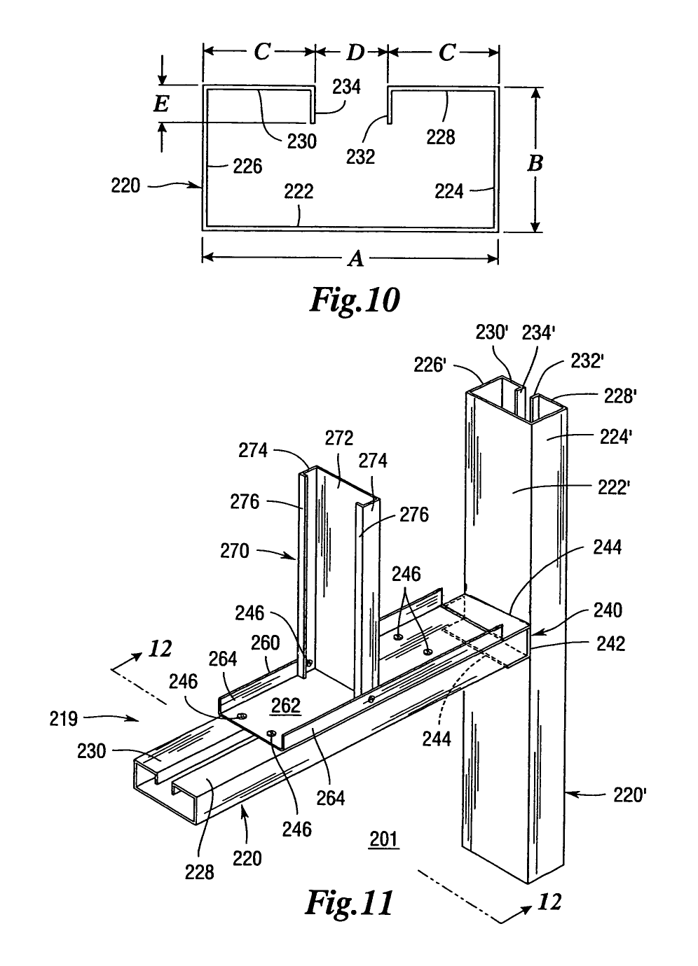

In this embodiment, the header assembly 219 is formed from a uniquely shaped header stud 220, one embodiment of which is depicted in FIG. 10. As can be seen in FIG. 10, stud 220 includes a substantially planar header web 222, a first header flange 224 and a second header flange 226. The first and second header flanges (224, 226) protrude outwardly from the substantially planar header web 222. A first header leg 228 protrudes from the first header flange 224 such that the first header leg 228 is substantially parallel to the substantially planar header web 222. Likewise, a second header leg 230 protrudes from the second header flange 226 such that it is substantially parallel to the substantially planar header web 222. A first header return 232 protrudes from the first header leg 228 and a second header return 234 protrudes from the second header leg 230.

In one embodiment, the stud 220 is rollformed from steel sheet by utilizing conventional rollforming methods and equipment. For example, the stud 220 may be fabricated from 12, 14, 16, 18, 20, etc. gage steel or other metal or material. Although the size of the stud 220 and the material from which it is formed may vary depending upon the application and loading conditions, in one embodiment for example, the web 222 may be made in various widths of, for example, 3⅝ inches, 6 inches and eight inches (distance “A”). The first and second flanges (224, 226) may be fabricated with a variety of different heights ranging from, for example, 2 inches-3.5 inches (distance “B”). The widths of the first and second legs (228, 230) of a stud that has a web width of 3⅝ inches may be 1 1/16 inches (distance “C”). Thus in this embodiment, the distance between the ends of the first and second legs (228, 230) is 1½ inches (distance “D”). The widths of the first and second legs (228, 230) of a stud that has a web width of six inches would be, for example, 2¼ inches. The widths of the first and second legs (228, 230) of a stud that has a web width of eight inches would be, for example, 3¼ inches. In various embodiments, the length of each return portion (232, 234) may be ¾ inches (distance “E”). It will be appreciated, however, that other sizes of stud 220 could be used depending upon the specific application.

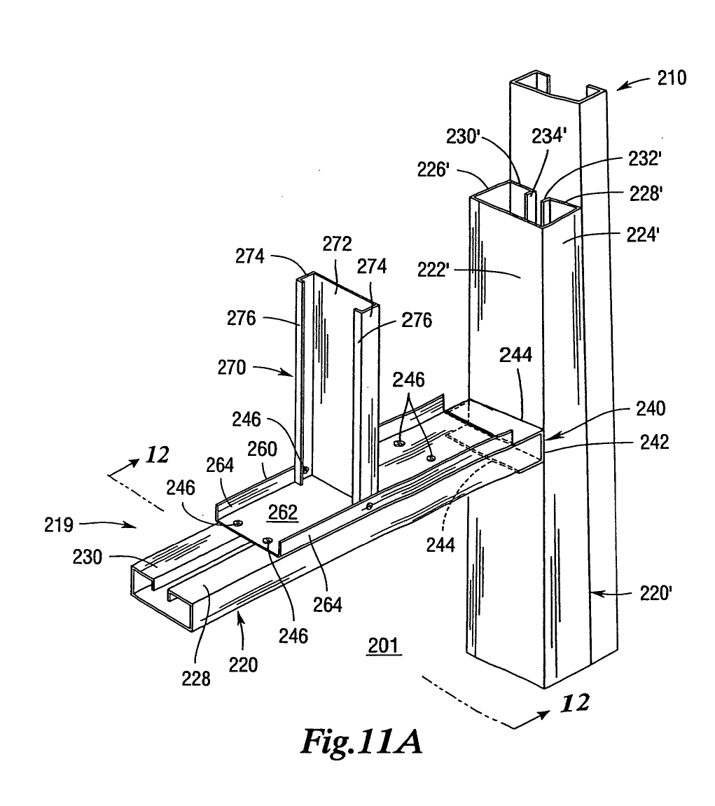

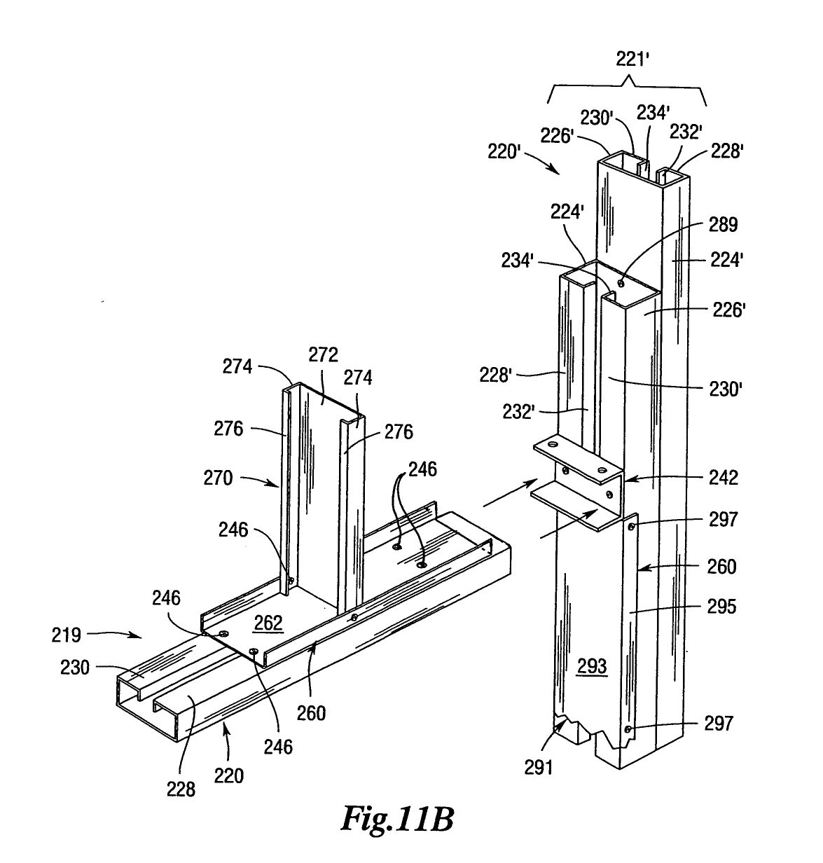

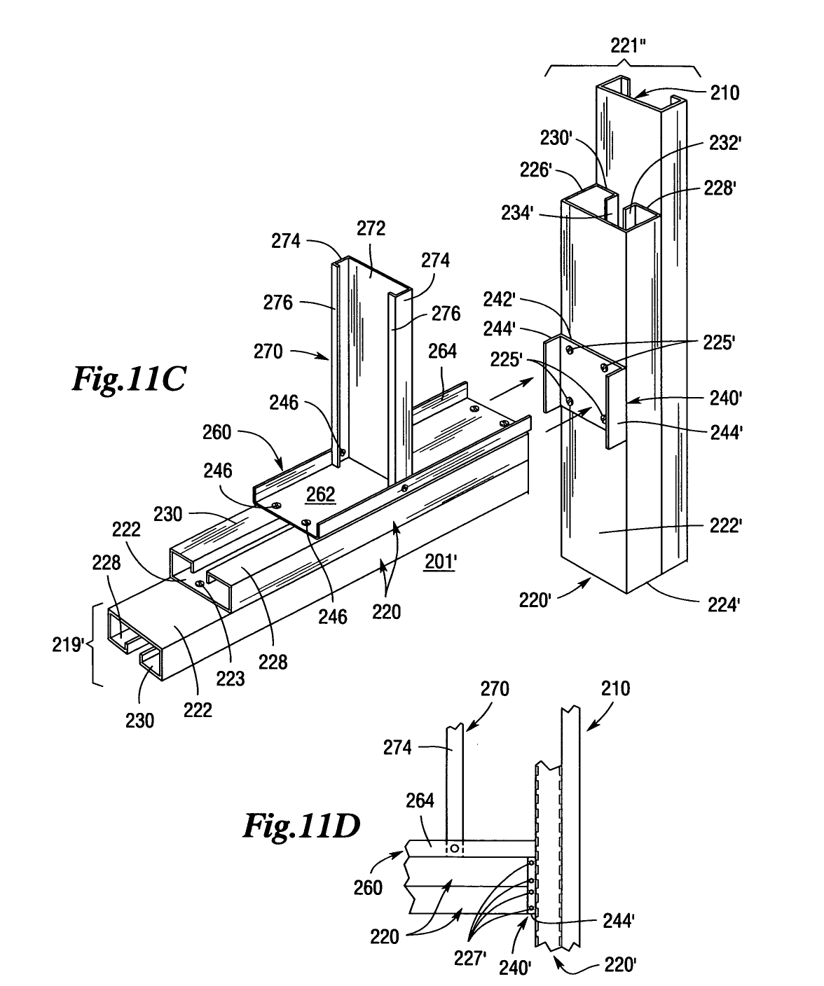

In the embodiment depicted in FIGS. 9 and 11, a header stud 220 is used to form the header assembly 219 and studs 220′ are used to form the jamb studs which form the vertical boundaries of the opening 201. Studs 220′ are identical to studs 220 and are identified herein with the “′” symbol to distinguish between the use of a stud 220 as a header and as a jamb stud. For example, each jamb stud 220′ has a substantially planar jamb stud web 222′, a first jamb stud flange 224′ and a second jamb stud flange 226′ that protrude from the jamb stud web 222′. A first jamb stud leg 228′ is attached or otherwise formed on the first jamb stud flange 224′ and a second jamb stud leg 230′ is formed on or attached to the second jamb stud flange 226′. A first jamb stud return 232′ is formed on the end of the first jamb stud leg 228′ and a second jamb stud return 234′ is formed on the end of the second jamb stud leg 230′. See FIG. 11. In this embodiment, the stud 220 is interposed between the jamb studs 220 and may be quickly coupled to the jamb studs 220′ by connector clips 240.

As can be seen in FIG. 13, in this embodiment, one connector clip embodiment has a clip web 242 and a pair of clip flanges 244 protruding from the clip web 242. The clip flanges 244 define a header-receiving space 245 therebetween. The clip web 242 of the clip 240 is fastened to the jamb stud web 222′ of the corresponding jamb stud 220′ by appropriately sized fasteners such as sheet metal screws or the like and one end of the header stud 220 is inserted between the clip flanges 242 as shown in FIG. 11. Each end of the header stud 220 is attached to the clip 240 utilizing threaded fasteners 246 such as sheet metal screws or the like. However, header stud 220 could be welded to the clip 240.

As shown in FIG. 11, in this embodiment, a header track 260 is supported on and attached to the first and second legs (228, 230) of the header stud 220. Header track 260 has a header track web 262 and a pair of upstanding header track flanges 264. The web 262 of the header track 260 is attached to the first and second header legs (228, 230) of the header stud 220 by fasteners 246 which may comprise conventional sheet metal screws or the like. In addition, pieces of studs 270, which may be conventional in nature, may be attached to the track header 260 and the upper track 206. Studs 270 may each have a web 272, pair of flanges 274 and a return 276 formed on the end of each flange 274. The flanges 274 of the studs 270 are attached to the header flanges 264 and the upper track flanges 208 by fasteners such as sheet metal screws or the like. Studs 270 serve as the cripple studs for the header arrangement. For window or door openings that require additional support due to their width, an additional conventional stud 210 could be attached to the jamb stud 220′ as shown in FIG. 11A.

FIGS. 9A and 11B illustrate the use of alternate header and jamb stud arrangements to form a window opening 201 in a wall frame structure 200. As can be seen in FIG. 11 B, two jamb studs 220′ are employed to form a jamb stud assembly 221′. In this embodiment, the web portions 222′ of the jamb studs 220′ may be attached in back-to back fashion by a plurality of screws 289 through the web portions 222′. For example, No. 10-16 screws may be employed and spaced at 12 inches on center to attach the two web portions 222′ together. In alternative embodiments, the jamb studs 220′ could be welded together or other fastener arrangements employed. To lend further support to the jamb stud assembly 221′, a C-shaped piece of track 291 may be attached to the one jamb stud 220′ as shown in FIG. 11B. The track 291 has a web portion 293 and a pair of flanges 295 and would extend down to the sill. The flanges 295 may be attached to the corresponding flanges 224′, 226′ of the jamb stud 220′ by screws 297 or by welding. In one example, No. 10-16 screws that are 24 inches on center may be employed. The track 291 may be located such that the connector clip 242 is attached immediately above the track 291 as shown. The track 291 may be employed or may not be employed depending upon how the window is attached to the jamb. The track serves to better facilitate attachment of the window assembly to the jamb. For example, for some windows, the inside face of the jamb will have to provide an attachment surface through the web depth. For other windows, the window can be secured to the jamb without adding track 291. One end of a header stud 220 of the type and construction described above is connected to the jamb stud assembly 221′ by connector clip 242 in the manner described above.

Also in this embodiment, a header track 260 is supported on and attached to the first and second legs (228, 230) of the upper header stud 220. Header track 260 has a header track web 262 and a pair of upstanding header track flanges 264. The web 262 of the header track 260 is attached to the first and second header legs (228, 230) of the header stud 220 by fasteners 246 which may comprise conventional sheet metal screws or the like. For example, in one embodiment, fasteners 246 comprise No. 10-16 screws. However, other fasteners and fastener arrangements could be employed. In addition, studs 270, which may be conventional in nature, may be attached to the header track 260 and the upper track 207. Studs 270 may each have a web 272, pair of flanges 274 and a return 276 formed on the end of each flange 274. The flanges 274 of the studs 270 are attached to the header flanges 264 and the upper track flanges by fasteners such as sheet metal screws or the like.

FIG. 9B illustrates use of the jamb stud assembly 221′ embodiment described above to form one vertical side of opening 201 and a “third” jamb stud 220′ to form the other vertical side of opening 201.

FIGS. 9C, 11C and 11D illustrate the use of a pair of header studs 220 for forming a header assembly 219′. Studs 220′ and 210 are used to form a jamb stud assembly 221 which forms the vertical boundaries of the opening 201′ in the manner described above. In this embodiment, the webs 222 of the header studs 220 may be interconnected by appropriately sized fasteners 223. In one embodiment, fasteners 223 comprise No. 10-16 screws spaced at 12 inches on center. However, other suitable fasteners and fastener arrangements may be employed. For example, the studs 220 may be welded together. It is also conceivable that, depending upon the load requirements, the upper stud 220 may be positioned on the lower stud 220 such that the legs (228, 230) of the upper stud 220 are received on the web 222 of the lower stud 220.

As can be seen in FIG. 11C, a connector clip 240′ is attached to the web 222′ of the jamb stud 220′ and is oriented to receive the two header studs 220 therein as shown in FIG. 11D. The connector clip 240′ has a web 242′ and a pair of flanges 244′ and is oriented such that the flanges 244′ extend vertically to receive the header studs 220 therebetween. The connector clip 240′ may be attached to the web of the jamb stud by appropriate fasteners 225′ and/or welded thereto. In one embodiment, fasteners 225′ comprise four No. 10-16 screws. However, other fasteners and fastener arrangements may be employed. The header studs 220 may be attached to the flanges 244′ by appropriate fasteners 227′ and/or be welded thereto. In one embodiment three No. 10-16 screws may be employed through each flange 244′. See FIG. 11D. However, other fasteners and fastener arrangements may be employed.

Also in this embodiment, a header track 260 is supported on and attached to the first and second legs (228, 230) of the upper header stud 220. Header track 260 has a header track web 262 and a pair of upstanding header track flanges 264. The web 262 of the header track 260 is attached to the first and second header legs (228, 230) of the header stud 220 by fasteners 246 which may comprise conventional sheet metal screws or the like. For example, in one embodiment, fasteners 246 comprise No. 10-16 screws. However, other fasteners and fastener arrangements could be employed. In addition, studs 270, which may be conventional in nature, may be attached to the header track 260 and the upper track 207. Studs 270 may each have a web 272, pair of flanges 274 and a return 276 formed on the end of each flange 274. The flanges 274 of the studs 270 are attached to the header flanges 264 and the upper track flanges by fasteners such as sheet metal screws or the like. However, studs 270 could also be welded to the header track 260. Studs 270 serve as the cripple studs for the header arrangement.

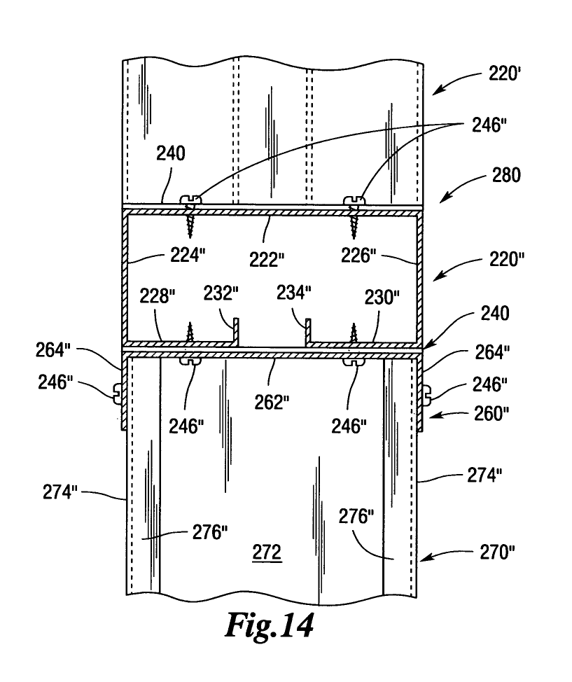

As can also be seen in FIGS. 9 and 14, sill studs 220″ may be used to form a windowsill designated as 280. Sill studs 220″ are identical to header studs 220 and are identified herein with the ″ symbol to distinguish between the use of a stud 220 as a header and as a sill stud. For example, each sill stud 220″ has a substantially planar sill stud web 222″, a first sill stud flange 224″ and a second sill stud flange 226″ that protrude from the sill stud web 222″. See FIG. 14. A first sill stud leg 228″ is attached or otherwise formed on the first sill stud flange 224″ and a second sill stud leg 230″ is formed on or attached to the second sill stud flange 226″. A first sill stud return 232″ is formed on the end of the first sill stud leg 228″ and a second sill stud return 234″ is formed on the end of the second jamb stud leg 230′.

In this embodiment, the sill stud 220″ is oriented with the flanges 224″ and 226″ extending toward the lower track 202 and is coupled to the jamb studs 220′ by connector clips 240 in the manner described above. Also in this embodiment, a sill track 260″ is supported on and attached to the first and second legs (228″, 230″) of the sill stud 220″. Sill track 260″ has a sill track web 262″ and a pair of upstanding sill track flanges 264″. The sill track web 262″ of the sill track 260″ is attached to the first and second sill track legs (228″, 230″) of the sill stud 220″ by fasteners 246″ which may comprise conventional sheet metal screws or the like. In addition, pieces of studs 270″, which may be conventional in nature, may be attached to the sill track 260″ and the lower track 202. Studs 270″ may each have a web 272″, pair of flanges 274″ and a return 276″ formed on the end of each flange 274″. The flanges 274″ of the studs 270″ are attached to the sill track flanges 264″ and the lower track flanges 208 by fasteners 246″ such as sheet metal screws or the like. Studs 270″ serve as the cripple studs for the sill 280.

Such header, jamb stud and sill arrangements of the present invention require less labor and material to assemble than the prior header configurations. It will also be appreciated, however, that the uniquely shaped studs 220, 220′, 220″ could be used in a variety of other applications and combinations. For example, the header studs 220 and the sill studs 220″ could be used to form headers and sills, respectively as described above in connection with conventional jamb stud arrangements. Likewise, the studs 220′ could be used to form jamb studs that are used in connection with conventional header and sill assemblies. Thus, it will be appreciated that the header studs 220 and/or sill studs 220″ do not have to be used in connection with jamb studs 220′ if use of other jambs stud arrangements is more preferable and visa-versa. It will be also appreciated that the studs (220, 220′, 220″) could be used in connection with wood studs and wood framing assemblies.

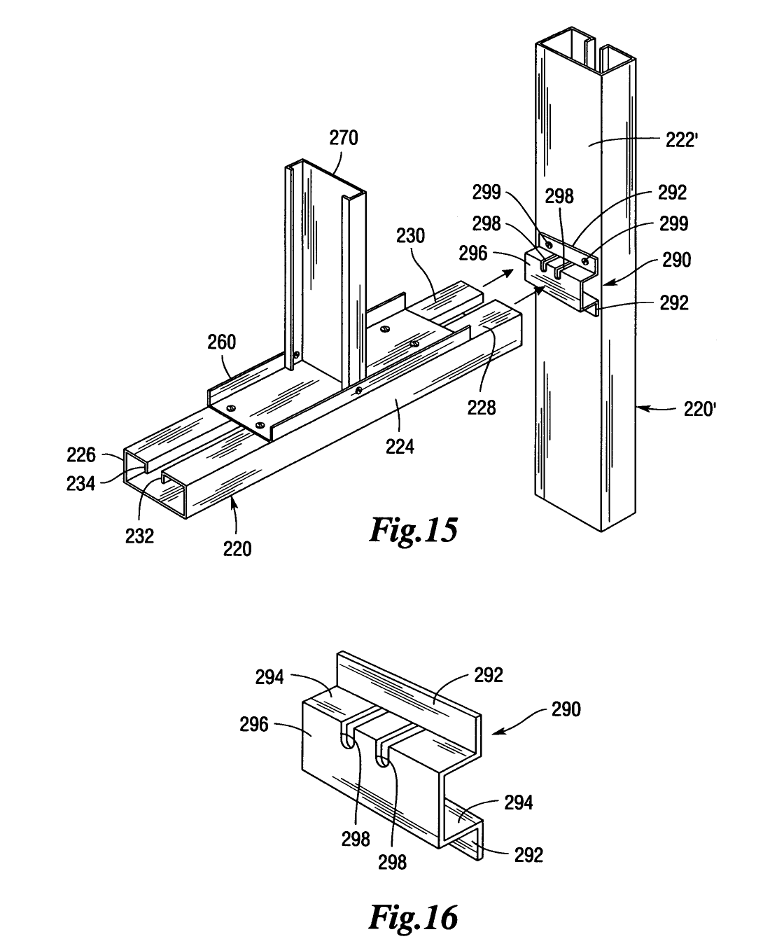

In another header assembly embodiment of the present invention, a connector clip 290 of the type illustrated in FIGS. 15 and 16 is employed. As can be seen in FIG. 16, the connector clip 290 has a pair of clip attachment tabs 292 and a raised central portion 296. The clip attachment tabs 292 are substantially coplanar with each other. The central portion 296 is substantially parallel to the clip attachment tabs 292 and is attached thereto by a pair of clip legs 294. The clip attachment tabs 292 are attached to the jamb stud web 222′ of the jamb stud 220′ by fasteners 299 such as sheet metal screws and the end of the header stud 220 is inserted over the central portion 296 such that the central portion 296 is received in the area between the first and second header flanges (224, 226) and the first and header second legs (228, 230). As can be seen in FIGS. 15 and 16, a pair of return-receiving slots 298 are provided in a portion of the central portion 296 and one of the clip legs 294 for receiving the first and second header returns (232, 234) when the ends of the header stud 220 is inserted over the raised central portion 286. The header stud 220 is then attached to the connector clip 290 by conventional fasteners such as such metal screws or the like. The header stud 220 could also be attached to the connector by welding or other fastener arrangements. Such connector clip arrangement may provide further torsional stability to the header stud 220 when installed in this manner. Connector 290 could also be used to attach the sill studs 220″ to the jamb studs 220′ in the above-described manners.

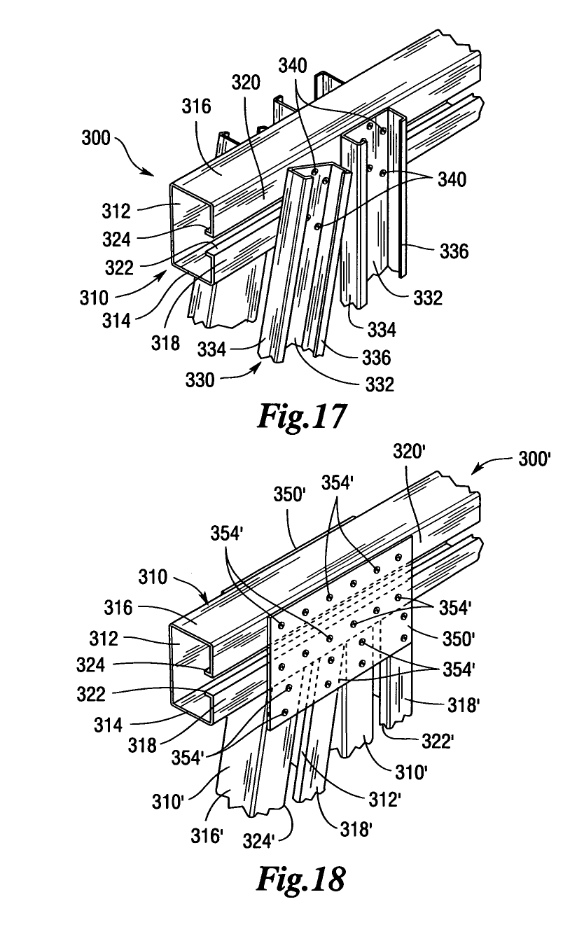

FIG. 17 illustrates a unique and novel truss chord arrangement 300 of one embodiment of the present invention. In this embodiment, a chord stud 310, which is essentially identical in construction as the header stud 220, is employed to form the truss chord. The chord stud 310 has a substantially planar chord web 312 and a first chord flange 314 and a second chord flange 316 protruding therefrom. A first chord leg 318 protrudes from the first chord flange 314 and a second chord leg 320 protrudes from the second chord flange 316. A first chord return 322 is formed on the end of the first chord leg 318 and a second chord return 324 is formed on the end of the second chord leg 320. Pieces of studs 330 which are conventional in nature are attached to the first and second chord legs (314, 316) and the chord web 312 of the chord stud 310 utilizing fasteners 340 such as sheet metal screws. The studs 330 each have a web 332, a pair of flanges 334 and a lip 336 formed on the end of each flange 334. These studs 330 form the webs of the truss. Such arrangement eliminates labor required to weld two pieces of stud together to form the truss chord.

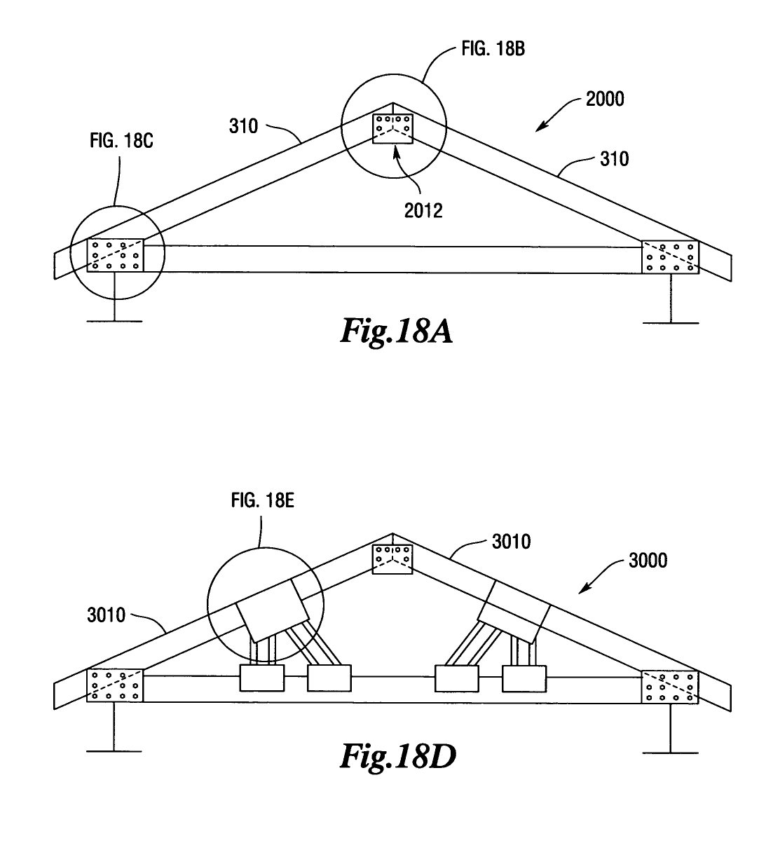

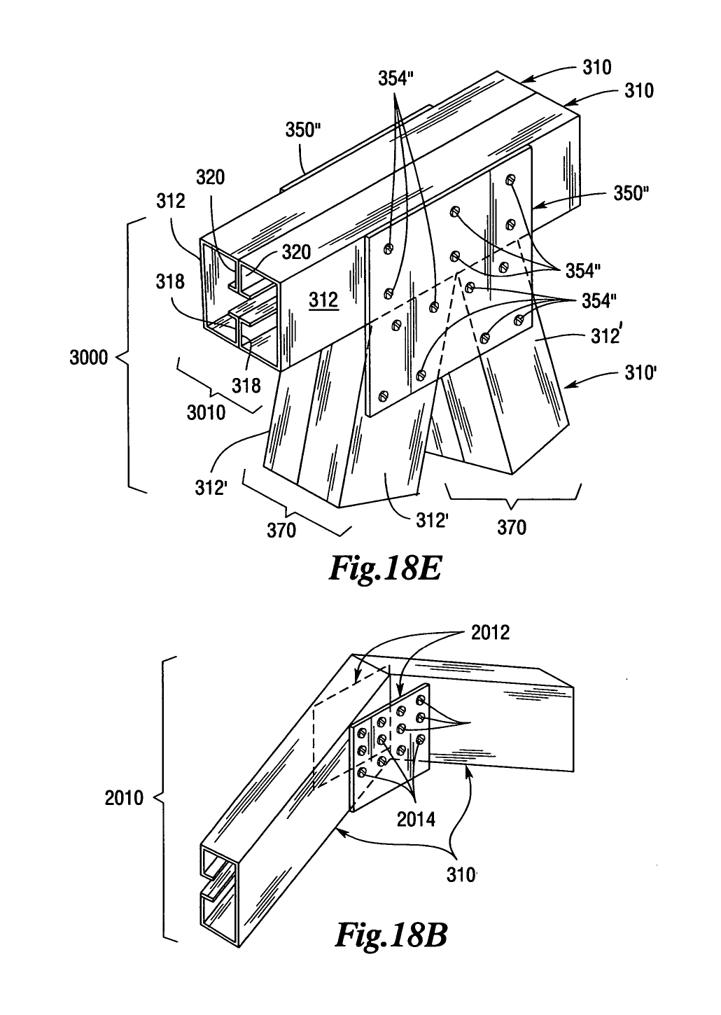

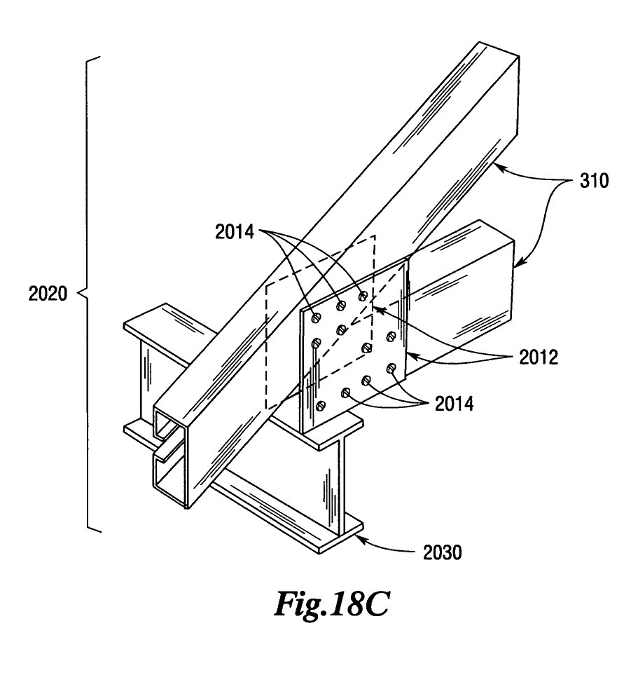

FIG. 18 illustrates another truss assembly 300′ of the present invention. In this embodiment, the truss webs are formed from truss studs 310′ which are each essentially identical in construction as the chord stud 310. Each truss stud 310′ has a substantially planar chord web 312′ and a first chord flange 314′ and a second chord flange 316′ protruding therefrom. A first chord leg 318′ protrudes from the first chord flange 314′ and a second chord leg 320′ protrudes from the second chord flange 316′. A first chord return 322′ is formed on the end of the first chord leg 318′ and a second chord return 324′ is formed on the end of the second chord leg 320′. In this embodiment, the truss studs 310″ are attached to the chord stud 310 by one or more gusset plates 350′ and fasteners 354′ such as sheet metal screws. The gusset plates 350′ may be fabricated from steel or other suitable material.

FIG. 18A illustrates a portion of a truss 2000 that employs various truss-related embodiments of the present invention. In one embodiment, two chord studs 310 of the type and construction described above form the upper chords of the truss 2000. The studs 310 are cut to form a pitch break 2010 of the truss 2000. The chord studs 310 are interconnected by one and preferably two gusset plates 2012 and fasteners 2014 of the type described above. See FIG. 18B.

FIG. 18C illustrates a truss heal detail 2020 that employs two truss chords 310 of the present invention that are coupled together utilizing gusset plates 2012 and fasteners 2014. As can be seen in the Figure, the stud 310 forming the lower truss chord is supported on a structure such as an I beam 2030 or the like.

FIG. 18D illustrates another truss assembly 3000 that employs another chord and web arrangement of the present invention. In this embodiment, the upper chords 3010 of the truss 3000 are each formed from a pair of chord studs 310. As can be seen in FIG. 18E, the chord legs 318, 320 of one chord stud 310 abut the chord stud legs 318, 320 of the other chord stud 310. The truss assembly 3000 further includes web assemblies 370 that each may comprise a pair of truss studs 310′ which are each essentially identical in construction as the chord stud 310. Each truss stud 310′ has a substantially planar chord web 312′ and a first chord flange 314′ and a second chord flange 316′ protruding therefrom. A first chord leg 318′ protrudes from the first chord flange 314′ and a second chord leg 320′ protrudes from the second chord flange 316′. A first chord return 322′ is formed on the end of the first chord leg 318′ and a second chord return 324′ is formed on the end of the second chord leg 320′. The chord webs 312′ of the chord studs 310′ are arranged to abut each other to form a single web assembly 370. The web assemblies 370 are then attached to the chord assembly 360 by one or more gusset plates 350″ and fasteners 354″ such as sheet metal screws. The gusset plates 350″ may be fabricated from steel or other suitable material.

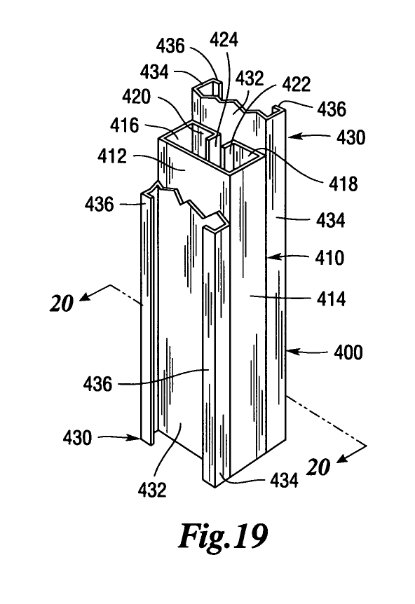

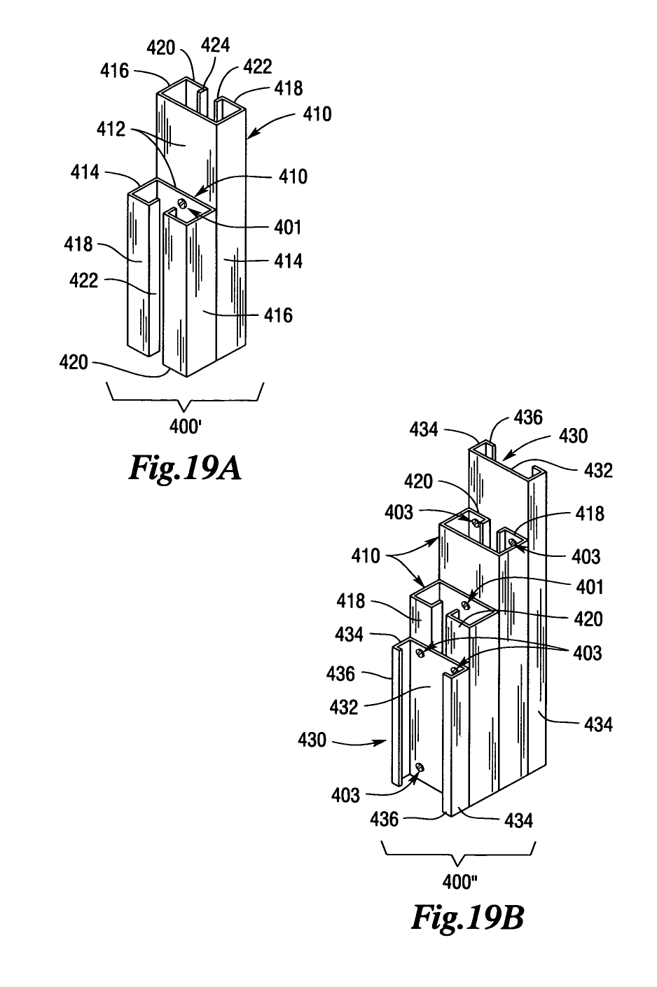

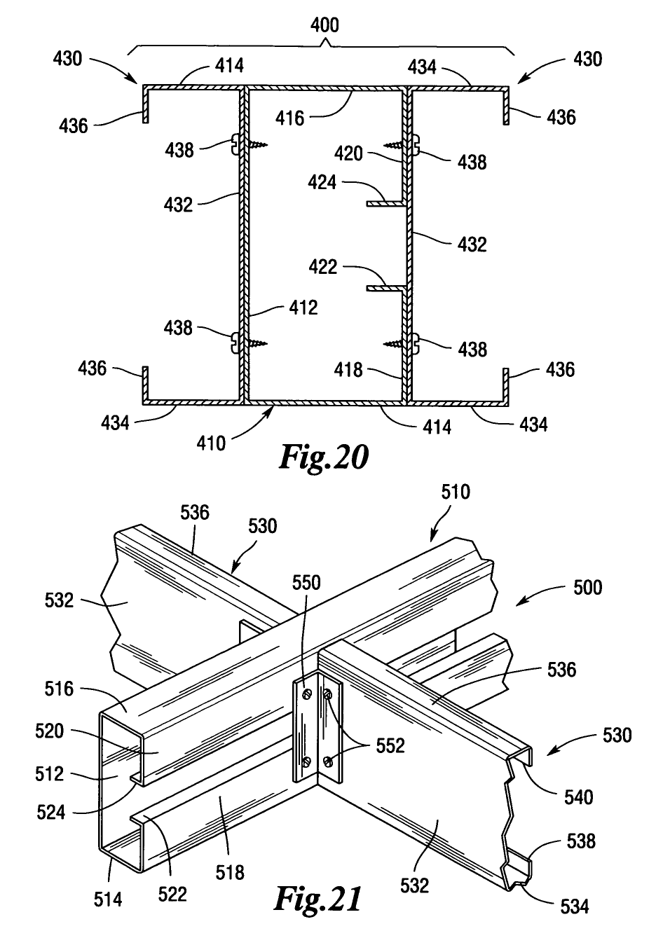

FIGS. 19 and 20 illustrate a support post 400 embodiment of the present invention that is formed utilizing a post stud 410 which is identical to the header stud 220 described above. The post stud 410 has a substantially planar post stud web 412 and a first post stud flange 414 and a second post stud flange 416 protruding from the post stud web 412. A first post stud leg 418 protrudes from the first post stud flange 414 and a second post stud leg 420 protrudes from the second post stud flange 416. A first post stud return 422 is formed on the end of the first post stud leg 418 and a second post stud return 424 is formed on the end of the second post stud leg 420. See FIG. 19.

In this embodiment, the post stud 410 is used in connection with two studs 430. The studs 430 each have a web 432 and two flanges 434. A lip 436 is formed on the end of each flange 434. The post 400 is formed by attaching the web 432 of one of the studs 430 to the post stud 412 of the post stud 410 with fasteners 438 such as sheet metal screws or the like and the web 432 of the other stud 430 is attached to the first and second post stud legs (418, 420) of the post stud 410 by sheet metal screws 438 or the like. I have discovered that such arrangement provides an equivalent amount of structural support as prior post arrangements that employ three conventional studs and two pieces of conventional track. Thus, this embodiment of the present invention reduces the amount of material needed and also the amount of labor needed to assemble it when compared to prior post assemblies. It will be appreciated, however, that the post stud 410 may also be used in connection with one stud 430 or more than two studs 430 without departing from the spirit and scope of the present invention.

FIG. 19A illustrates a support post 400′ embodiment of the present invention that is formed utilizing a pair of post studs 410 which are each identical to the header stud 220 described above. Each post stud 410 has a substantially planar post stud web 412 and a first post stud flange 414 and a second post stud flange 416 protruding from the post stud web 412. A first post stud leg 418 protrudes from the first post stud flange 414 and a second post stud leg 420 protrudes from the second post stud flange 416. A first post stud return 422 is formed on the end of the first post stud leg 416 and a second post stud return 424 is formed on the end of the second post stud leg 420. In this embodiment, the post studs 410 are arranged such that the post stud webs 412 are back-to back and interconnected by an appropriate number of appropriately sized fasteners 401 and/or be attached together by welding. In one embodiment, fasteners 401 comprise No. 10-16 screws that are arranged at 12 inches on center. However, other types and arrangements of fasteners may be used. In alternative embodiments, depending upon the application and load requirements, the post stud legs 418, 420 of one post stud 410 may be attached to the post stud web 412 of the other post stud 410 or the post stud legs 418, 420 of one post stud 410 may be attached to the post stud legs 418, 420 of the other post stud 410. In addition, as shown in FIG. 19B, additional studs 430 of the type and construction described above may be attached to the pair of post studs 410 to form a support post 400″ as shown. In that embodiment, the webs 432 of each of the studs 430 are attached to the legs 418, 420 of the corresponding stud by fasteners 403. In one embodiment, fasteners 403 comprise No. 10-16 screws arranged in pairs that are spaced at 24 inches on center. However, other fasteners and fastener arrangements could be employed. For example, the studs 430 may be welded to the respective post studs 410.

The unique and novel studs of the present invention may also be used as a floor girder 502 in a floor system 500. More particularly and with reference to FIG. 21, a single girder stud 510 serves as a floor girder for attaching conventional floor joists 530 thereto. The girder stud 510 is identical in construction when compared to the header stud 220 described above. In one embodiment, the girder stud 510 has a substantially planar girder web 512 and a first girder flange 514 and a second girder flange 516 protruding from the girder web 512. A first girder leg 518 protrudes from the first girder flange 514 and a second girder leg 520 protrudes from the second girder flange 516. A first girder return 522 is formed on the end of the first girder leg 518 and a second girder return 524 is formed on the end of the second girder leg 520.

The floor joists 530 may have a joist web 532 and a first joist flange 534 and a second joist flange 536. A first joist lip 538 is formed on the end of the first joist flange 534 and a second joist lip 540 is formed on the end of the second joist flange 536. One series of joists 530 are attached to the first and second girder legs (518, 520) of the girder stud 510 by conventional L-shaped clips 550 and sheet metal screws 552 or the like. The joists 530 protruding from the other side of the girder stud 510 are attached to the girder web 512 of the girder stud 510 by L-shaped clips 550 and fasteners 552. Such improved arrangement eliminates the need to assemble the girder from a conventional stud and track and the labor associated with making such girder. It will be further appreciated that the girder of the present invention may find utility in non-floor applications without departing form the spirit and scope of the present invention.

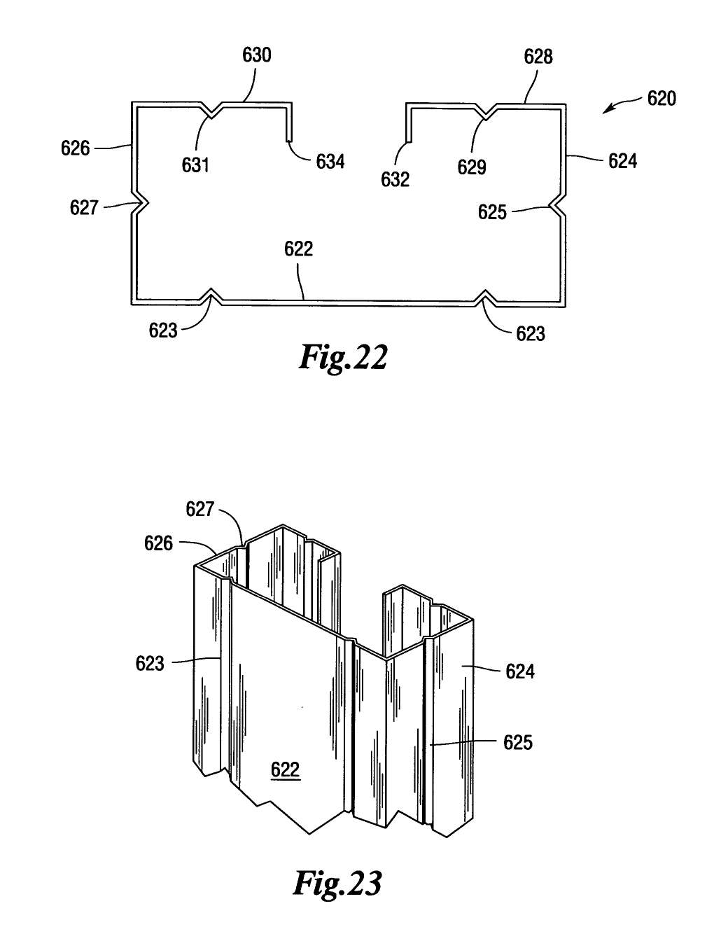

FIGS. 22 and 23 illustrate an alternative stud embodiment 620 of the present invention. Stud 620 includes a web 622, a first flange 624 and a second flange 626. The first and second flanges (624, 626) protrude outwardly from the web 622. A first leg 628 protrudes from the first flange 624 such that the first leg 628 is substantially parallel to the web 622. Likewise, a second leg 630 protrudes from the second flange 626 such that it is substantially parallel to the web 622. A first return 632 protrudes from the first leg 628 and a second return 634 protrudes from the second header leg 630. See FIG. 22.

In one embodiment, the stud 620 is rollformed from steel sheet by utilizing conventional rollforming methods and equipment. For example, the stud 620 may be fabricated from 12, 14, 16, 18, 20, etc. gage steel or other metal or material. In this embodiment, the stud 620 may further include a series of stiffener ribs. More particularly and with reference to FIG. 22, the web 622 may have one or more web stiffener ribs 623 therein. Web stiffener ribs 623 may continuously extend the entire length of the web 622 or they may, for example, be provided in an intermittent manner along the web 622. Similarly, flange stiffener ribs may be provided in the flanges 624 and/or 626. For example, at least one first flange stiffener rib 625 may be provided in the first flange 624. The first flange stiffener rib 625 may continuously extend the entire length of the first flange 624 or it may be intermittently provided therein. At least one second flange stiffener rib 627 may be provided in the second flange 626. The second flange stiffener rib 627 may extend the entire length of the second flange 626 or it may be intermittently provided therein. In addition, at least one first leg stiffener rib 629 may be provided in the first leg 628. The first leg stiffener rib 629 may continuously extend the entire length of the first leg 628 or it may be intermittently provided therein. At least one second leg stiffener rib 631 may be provided in the second leg 630. The second leg stiffener rib 631 may extend the entire length of the second leg 630 or it may be intermittently provided therein. Various stud embodiments may include one or more web stiffener ribs, flange stiffener ribs and leg stiffener ribs or any combination thereof depending upon the specific application. For example, one embodiment may only include at least one stiffener rib in the web of the stud. Another embodiment may only include at leas one stiffener rib in each flange. Another embodiment may include at least one stiffener rib in each of the legs. Still another embodiment may include at least one stiffener rib in the flanges, but not in the web. Another embodiment may include at least one stiffener rib in each leg, but nowhere else in the stud. Another embodiment may include at least one stiffener rib in each leg and at least one stiffener rib in the web, but not in the flanges. The present disclosure is meant to encompass all permutations and combinations of stiffener ribs without departing from the spirit and scope of the present invention.

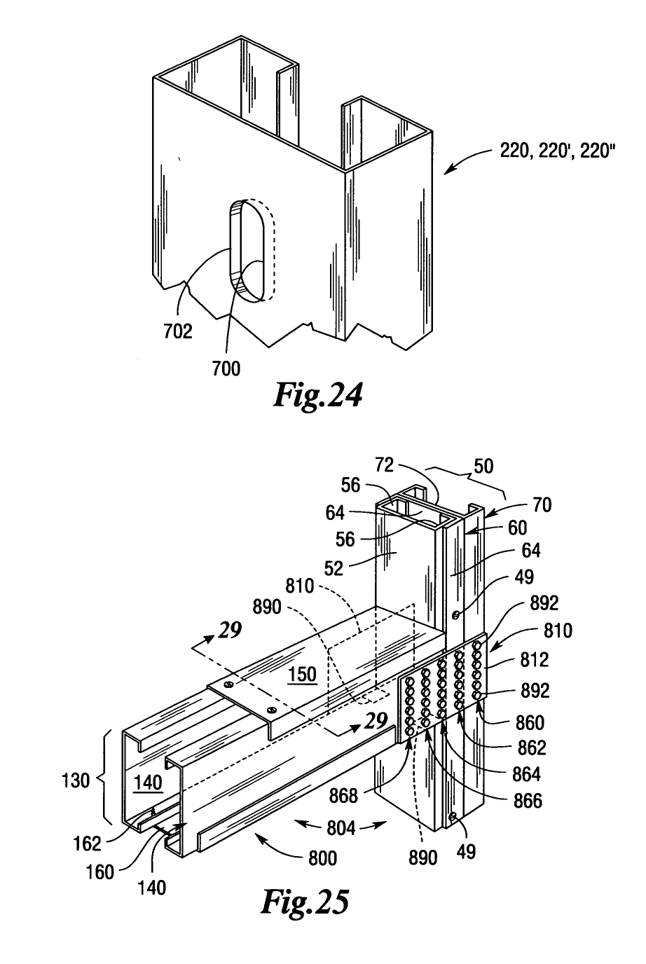

In yet another embodiment, one or more access holes 700 may be provided through the webs of studs 220, 220′, 220″, 620 disclosed herein. See FIG. 24. The access holes may be formed in the webs of the respective studs such that a flange 702 extends around the perimeter of the hole 700. Studs containing such holes could be used in any of the above-described embodiments to form, for example, headers, sills, jamb studs, truss chords, posts, and girders.

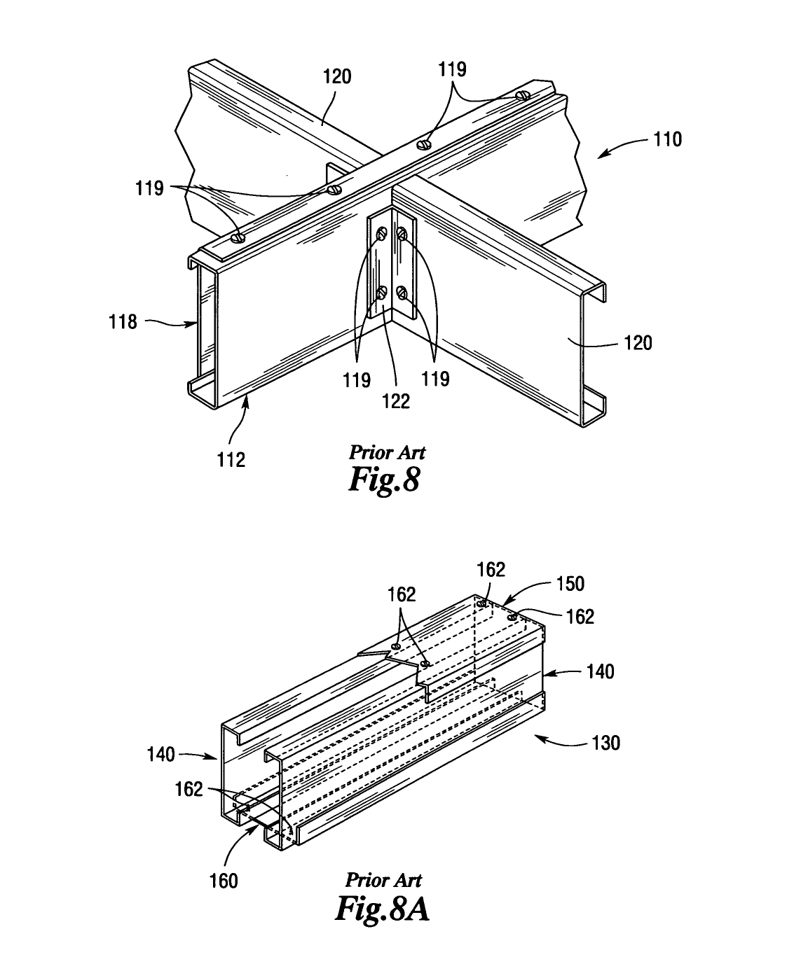

FIG. 25 illustrates a portion of a lintel arrangement 800 that is spaced between conventional jamb studs 50 of the type and construction described above to form the top of a door or window opening 804. As was described above, the jamb studs 50 are each commonly formed by attaching a C-shaped stud 52 to another piece of track 60 such that the flanges 56 of the stud 52 are received between the flanges 64 of the track 60 and then attaching the web 72 of another stud 70 to the web 64 of the track 60. These components are also commonly coupled together with screws 49 or, in the alternative, they may be welded together to form the jamb stud 50. This embodiment employs unique and novel connectors 810 to fasten a conventional header 130 of the type and construction depicted in FIG. 8A to the jamb studs 50.

As described above, the conventional header 130 is formed from two conventional studs or C-shaped members 140 that are retained in spaced-apart relationship relative to each other between a piece of upper track 150 and a piece of lower track 160. The pieces are held together by a collection of screws 162 or by welding.

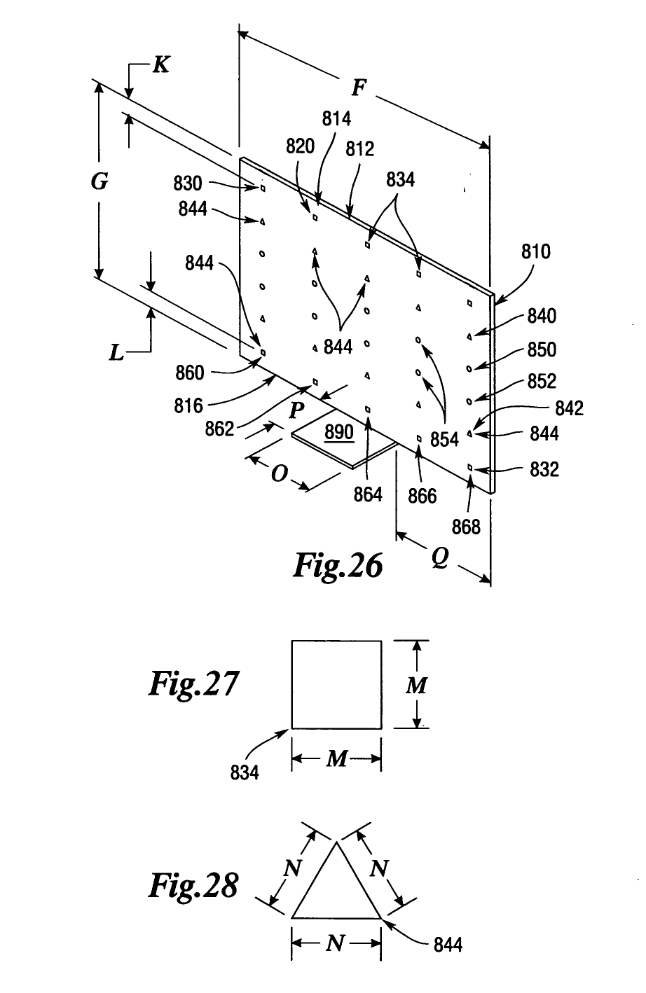

One embodiment of the unique and novel connectors 810 of the present invention is depicted in FIG. 26. As can be seen in that Figure, the connector 810 comprises a substantially planar connection plate 812 that is fabricated from suitable material that is capable of withstanding the anticipated loading conditions in accordance with the relevant building codes and design requirements. For example, the connection plate 812 may be fabricated from 12, 14 or 16 gauge metal or other suitable material. In one embodiment, the connection plate 812 is substantially rectangular in shape. For example, in the embodiment depicted in FIG. 26, the plate 812 may be approximately 8.5 inches long (distance “F”) and approximately 6 inches high (distance “G”). However, other plate sizes may be employed.

The connection plate 812 may be provided with a collection of fastener holes collectively designated as 820. In one embodiment, the holes 820 may all have the same dimensions and shape. For example, the holes 820 may all be round and sized to accommodate the appropriate size of fastener. In alternative embodiments. If different sizes of fasteners are desirable, the holes may have like shapes by have different sizes to accommodate different sizes of fasteners.

In the embodiment depicted in FIG. 26, however, a unique and novel fastener hole arrangement is employed. In one embodiment, at least two different shapes of holes are employed. In the embodiment depicted in FIG. 26, for example, three different shapes of holes are employed. As can be seen in FIG. 26, two rows 830, 832 of linearly aligned first holes 834 are provided through the connection plate 812. Row 830 of first holes 834 is adjacent the upper edge 814 of the connection plate 812. In this embodiment, the distance from the upper edge 814 to the centerlines of the holes 834 in row 830 is approximately 0.5 inches (distance “K”). Row 832 of first holes 834 is adjacent the lower edge 816 of the connection plate 812. In this embodiment, the distance from the lower edge 816 to the centerlines of the first holes 834 in the row 832 is approximately 0.5 inches (distance “L”). As can be seen in FIGS. 26 and 27, the first holes 834 are square-shaped. The square-shaped first holes 834 are sized to accommodate the desired fasteners that are to be installed through those holes. For example, the square-shaped first holes 834 may be approximately 3/32 inch square (distance “M” in FIG. 27) to accommodate No. 10-16 screws. However other sizes and types of fasteners may be employed

Also in this embodiment, a collection of second holes 844 are provided through connection plate 812. Second holes 844 each have a second shape that differs from the shape of the first holes 834. More particularly in this embodiment, rows 840, 842 of linearly aligned second holes 844 are provided through the connection plate 812 in the locations shown in FIG. 26. That is, row 840 is adjacent to the row 830 and row 842 is adjacent to row 832. In this embodiment, the centerlines of the second holes 844 in the row 840 are spaced approximately 1.0 inches from the centerlines of the first holes 834 in the row 830. Likewise, the centerlines of the second holes 844 in the row 842 are approximately 1.0 inches from the centerlines of the first holes 834 in row 832. In this embodiment, the second holes 844 are triangular-shaped and sized to accommodate the desired fasteners. In one embodiment, the sides of the second holes 844 may be approximately ⅛ inch long (distance “N” in FIG. 28) to accommodate No. 10-16 screws. However other types and sizes of fasteners may be employed.

As can also be seen in FIG. 26, in this embodiment, two rows 850, 852 of linearly aligned third holes 854 are provided through the connection plate 812. The shape of each of the third holes 854 differs from the “first” shape of each of the first holes 834 and the “second” shape of second holes 844. In this embodiment, the centerline of the linearly aligned third holes 854 in row 850 is spaced approximately 1.0 inch from the centerline of linearly aligned second holes 844 in row 840. Likewise, the centerline of the linearly aligned third holes 854 in row 852 is approximately 1.0 inch from the centerline of the linearly aligned second holes 844 in row 842 and also approximately 1.0 inch from the centerline of the linearly aligned third holes 854 in row 850. The third holes 854 in this embodiment are round and sized to accommodate the desired fasteners. In one embodiment, for example, the third holes 854 are approximately 5/32 inches in diameter and may accommodate No. 10-16 screws. However, other types and sizes of fasteners may be employed.

In this embodiment, the first holes 834, second holes 844 and third holes 854 are further aligned to form a first column of linearly aligned holes designated as first column 860, a second column of linearly aligned holes designated as second column 862, a third column of linearly aligned holes designated as third column 864, a fourth column of linearly aligned holes designated as fourth column 866 and a fifth column of linearly holes designed as fifth column 868.

Each particular hole shape has a load capacity associated with it. That is, by filling all of the first holes 834 with appropriately sized fasteners that correspond to those holes, a first predetermined load capacity for the connection may be attained. By filling all of the second holes 844 with appropriately sized fasteners that correspond to those holes, a second predetermined load capacity for the connection may be achieved. By filling all of the third holes 854 with appropriately sized fasteners that correspond to those holes, a third load capacity may be achieved for the connection. By filling only all of the first and second holes 834, 844 with appropriately sized fasteners corresponding to those holes, a fourth predetermined load capacity may be achieved. By filling only all of the first and third holes 834, 854 with appropriately sized fasteners corresponding to those holes, a fifth predetermined load capacity may be achieved. By filling only all of the second and third holes 844, 854 with appropriately sized fasteners corresponding to those holes, a sixth predetermined load capacity for the connection may be achieved. By filling all of the first, second and third holes 834, 844, 854 with corresponding fasteners, a seventh predetermined load capacity for the connection may be achieved.

The following chart provides an example of the loading characteristics that may be achieved using conventional connectors:

| | Framing | Framing | 10 Screws | | 20 Screws | | 30 Screws | |
|---|---|---|---|---|---|---|---|---|
| | Gauge | Fy | Jamb | Header | Jamb | Header | Jamb | Header |
| Connector | (Mils) | (ksi) | Capacity | Capacity | Capacity | Capacity | Capacity | Capacity |
| H436 | 20 (33) | 33 | 561 | 307 | 1121 | 507 | 1361 | 637 |
| Using | 18 (43) | 33 | 832 | 455 | 1361 | 753 | 1361 | 945 |
| #12-16 | 16 (54) | 33 | 832 | 455 | 1361 | 753 | 1361 | 945 |
| Screws | | 50 | 832 | 455 | 1361 | 753 | 1361 | 945 |
| | 14 (68) | 33 | 832 | 455 | 1361 | 753 | 1361 | 945 |
| | | 50 | 832 | 455 | 1361 | 753 | 1361 | 945 |
| | 12 (97) | 33 | 832 | 455 | 1361 | 753 | 1361 | 945 |
| | | 50 | 832 | 455 | 1361 | 753 | 1361 | 945 |
| H546 | 20 (33) | 33 | 561 | 307 | 1121 | 507 | 1682 | 637 |
| Using | 18 (43) | 33 | 832 | 455 | 1664 | 753 | 2496 | 945 |
| #10-16 | 16 (54) | 33 | 1172 | 641 | 2345 | 1061 | 2634 | 1332 |
| Screws | | 50 | 1682 | 919 | 2634 | 1522 | 2634 | 1910 |
| | 14 (68) | 33 | 1655 | 905 | 2634 | 1498 | 2634 | 1880 |
| | | 50 | 1682 | 919 | 2634 | 1522 | 2634 | 1910 |
| | 12 (97) | 33 | 1682 | 919 | 2634 | 1522 | 2634 | 1910 |
| | | 50 | 1682 | 919 | 2634 | 1522 | 2634 | 1910 |
| H686 | 20 (33) | 33 | 630 | 344 | 1260 | 570 | 1890 | 716 |
| Using | 18 (43) | 33 | 935 | 511 | 1870 | 846 | 2805 | 1062 |
| ¼″-14 | 16 (54) | 33 | 1318 | 720 | 2635 | 1193 | 3821 | 1497 |
| Screws | | 50 | 1997 | 1091 | 3821 | 1807 | 3821 | 2268 |
| | 14 (68) | 33 | 1860 | 1017 | 3720 | 1684 | 3821 | 2113 |
| | | 50 | 2818 | 1541 | 3821 | 2551 | 3821 | 3201 |
| | 12 (97) | 33 | 2818 | 1541 | 3821 | 2551 | 3821 | 3201 |
| | | 50 | 2818 | 1541 | 3821 | 2551 | 3821 | 3201 |

The skilled artisan will appreciate that the unique and novel fastener hole arrangement of the connection plate embodiment of the present invention may be adapted to assist the installer in quickly attaining the desired load capacity when coupling a header 130 to a jamb stud 50. By locating the holes in the necessary locations and providing the installer with information indicating: (i) the type and size of fastener associated with each shape of hole and (ii) an indication of the load capacity attainable by employing fasteners through particular shapes of holes, the installer will be able to quickly achieve a connection that will have the desired load capacity characteristics. It will be further appreciated that particular shapes and orientations of the fastener holes depicted in FIG. 26 are merely illustrative of one embodiment of the connection plate of the present invention. The numbers, locations and particular shapes of holes may vary with the size of the plate employed and the load capacity required. For example, the rows of square holes may be provided where the rows of round holes are located and the rows of round holes may be provided where the rows of square holes are located, ect. Thus, the scope of protection afforded to the connection plate of the present invention should not be limited to the particular shape and arrangements of holes depicted in FIGS. 26-28 and described above. A myriad of different shapes, sizes and arrangements of holes are contemplated.

To aid in the quick positioning of the connection plate 812 such that it properly spans between the jamb stud 50 and the header 130 and the fastener holes are oriented in desired positions to facilitate fastening of the plate 812 in the desired position, a locator tab 890 is formed on the lower parametrical edge 816 of the connection plate 812. In one embodiment, the locator tab 890 is substantially planar and substantially rectangular in shape and protrudes outward from the connection plate such that it is substantially perpendicular thereto. For example, the locator tab 890 may be approximately 2 inches long (distance “O”) and approximately 1.5 inches wide (distance “P”). For use in connection with conventional jamb stud assemblies, the locator tab 890 may be located approximately 3.25 inches from the end of the connection plate 812 (distance “Q”).

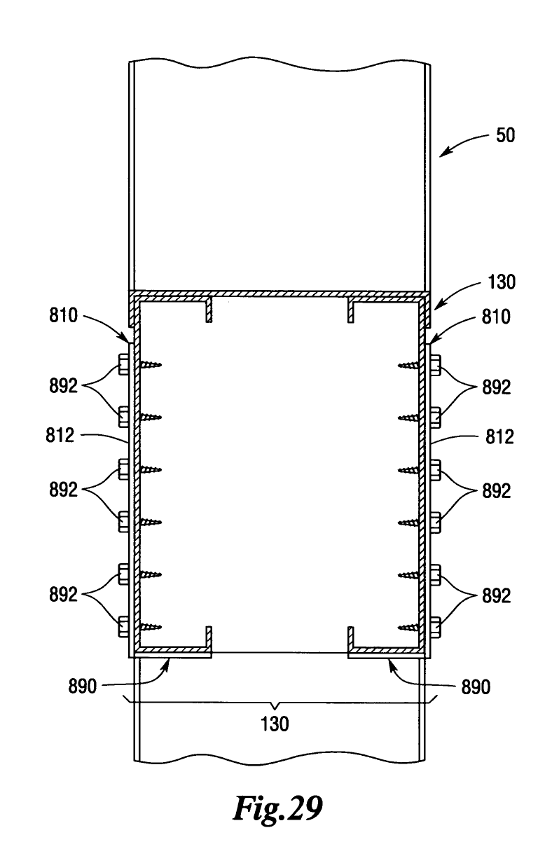

FIGS. 25 and 29, illustrate use of one embodiment of the connector 810 of the present invention to connect a conventional header 130 to a conventional jamb stud 50. As can be seen in those Figures, the installer places the locator tab 890 under the header 130 and moves it into abutting contact with the jamb stud 50. The locator tab 890 serves to position the connector 810 such that the first and second columns 860, 862 of holes are aligned to permit fasteners 892 to be installed through the holes of those columns and into the jamb stud 50. Likewise, the columns 864, 866, 868 of holes are located to permit fasteners to be inserted therethrough into the header 130. The reader will appreciate that two connectors 810 may be employed to attach one end of the header 130 to the corresponding jamb stud 50. Thus, four connectors 810 may be employed to attach the ends of the header 130 to two spaced jamb studs 50 to form a window, door or other opening. Such unique and novel arrangement of the connector 810 enables the connector 810 to be used on either side and either end of the header for attachment purposes. This is can be a very useful advantage when compared with other types of connector arrangements employed to connector headers to jamb studs. Such connector arrangements require different connectors for connecting left and right ends of the header to the jamb stud. This undesirable feature requires the installer to have both types of connectors on hand during the construction process. Whereas, when using the connector 810 of the present invention, only one type of connector is required.

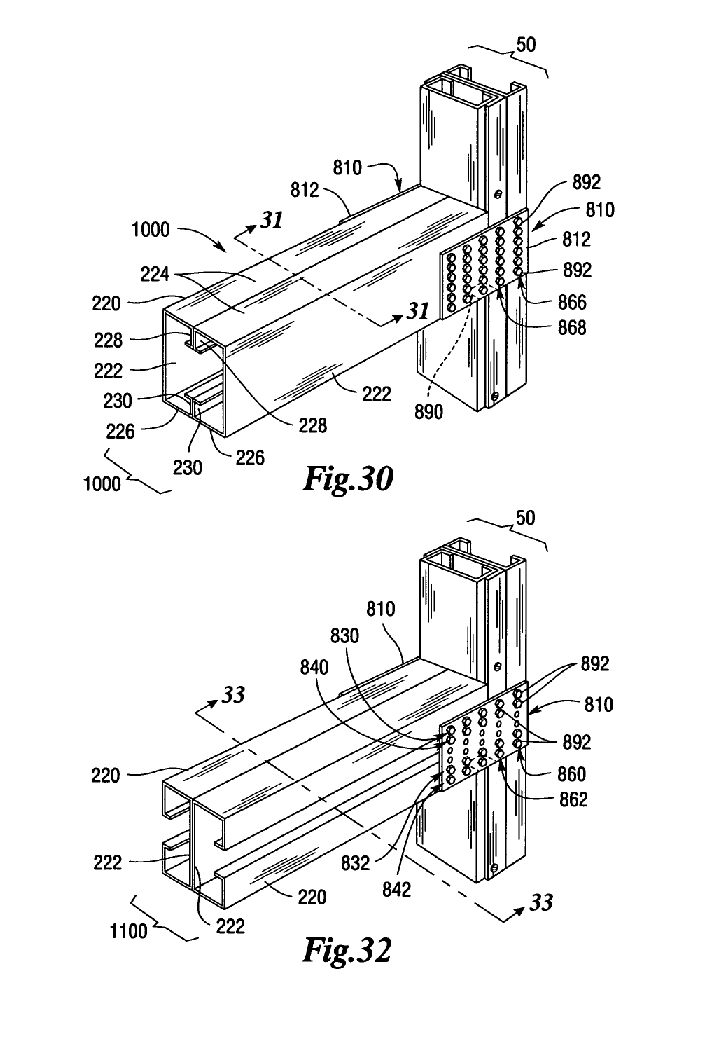

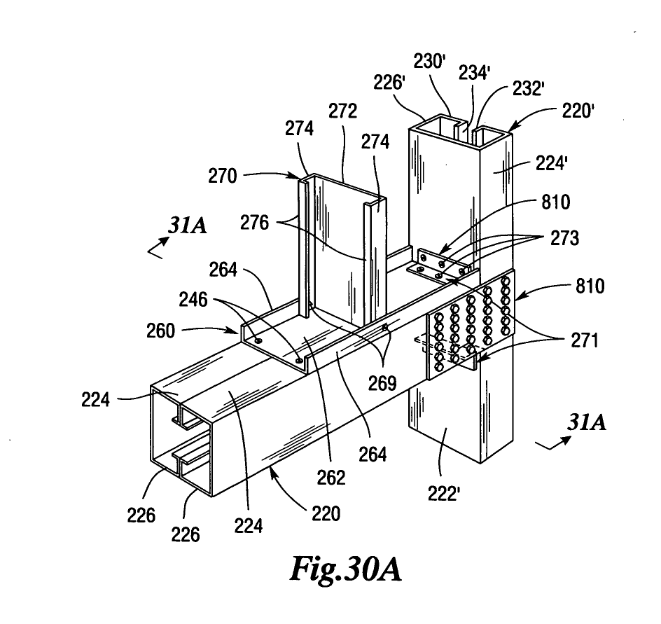

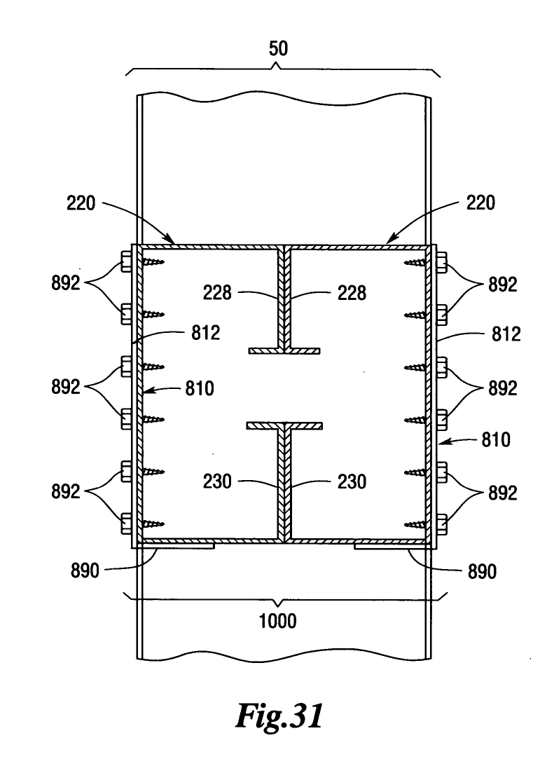

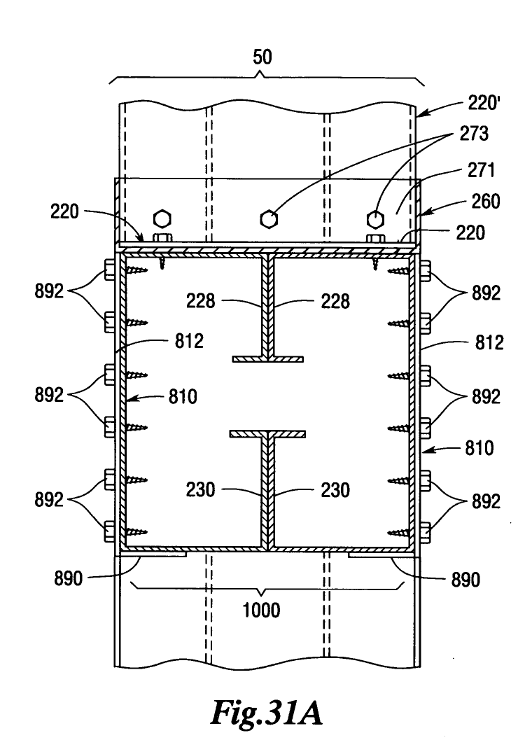

The connector 810 of the present invention may also be effectively used in connection with header studs 220 of the type and construction described above. In particular and with reference to FIGS. 30 and 31, a header assembly embodiment 1000 of the present invention is depicted for use in connection with a conventional jamb stud 50. In this embodiment, header assembly 1000 includes a pair of header studs 220 that are arranged such that the first leg 228 of one header stud 220 is in abutting contact with the first leg 228 of the other header stud 220. Likewise, the second leg 230 of the one header stud 220 is in abutting contact with the second leg 230 of the other header stud 220 as shown in FIGS. 30 and 31.

A pair of connector plates 810 is used on each end of the header assembly 1000 to attach one end of the header assembly 1000 to the corresponding jamb stud 50. Fasteners 892 such as 10-16 screws, etc. are inserted through the holes in the connector plate 812 of the connectors 810. FIGS. 30 and 31 illustrate use of fasteners 892 through all of the holes in the connector plate 812. The reader will appreciate that the number and types of fasteners 892 employed may vary depending upon the load capacity desired and the corresponding hole shapes that must be filled with a corresponding fastener 892. The locator tab 890, when abutted against the jamb stud 50, serves to locate the columns 866 and 868 of holes through the connector plate 812 along the jamb stud 50 for attachment of the plate 812 thereto. The header studs 220 in this embodiment may or may not be attached to each other by other fasteners (screws) or by welding. In those embodiments wherein the header studs 220 are not independently attached to each other, they are simply sandwiched together at their respective ends between the corresponding pairs of connectors 810.

FIGS. 30A and 31A illustrate the use of a header track 260 and cripple stud arrangement of the type and construction described with the embodiment of FIGS. 30 and 31. As can be seen in FIGS. 30A and 31A, a header track 260 is supported on and attached to the flanges 224 of the header studs 220. Header track 260 has a header track web 262 and a pair of upstanding header track flanges 264. The web 262 of the header track 260 is attached to the flanges 224 of the header studs 220 by fasteners 246 which may comprise conventional sheet metal screws or the like. In addition, pieces of studs 270, which may be conventional in nature, may be attached to the header track 260 and the upper track (not shown). Studs 270 may each have a web 272, pair of flanges 274 and a return 276 formed on the end of each flange 274. The flanges 274 of the studs 270 are attached to the header flanges 264 and the upper track flanges 208 by fasteners 269 such as sheet metal screws or the like. Studs 270 serve as the cripple studs for the header arrangement. A pair of L-shaped clip angles 271 may be employed as shown to complete the connection. As can be seen in FIGS. 30A and 31A, one leg of the upper L-shaped clip angle 271 is attached to the web 222′ of the jamb stud 220′ and the other leg of the clip angle 271 may be attached to the web 262 of the header track 260 and underlying flanges 224 of the header studs 220 by appropriate fasteners 273. In one embodiment No. 10-16 screws are employed. However, other fasteners may be employed. The legs of the L-shaped clip angle 271 may be welded to the webs, if desired. Similarly, on leg of the lower L-shaped clip angle 271 is attached to the web 222′ of the jamb stud 220′ and the other leg of the clip angle 271 is attached to the flanges 226 of the header studs 220 by other fasteners 273. See FIG. 31A.

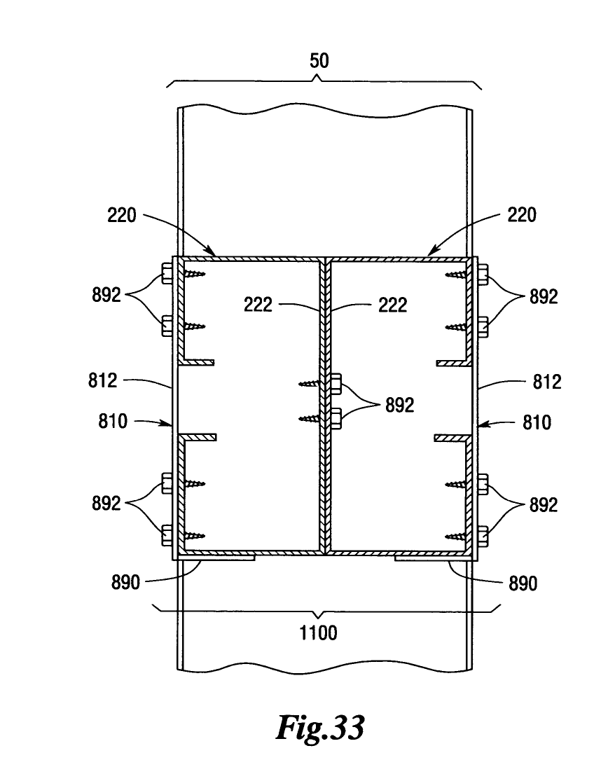

FIGS. 32 and 33 illustrate the use of the connector plates 810 of the subject invention in connection with an alternative header assembly 1100 of the present invention which also employs a pair of header studs 220 of the type and construction described above. In this embodiment, the web 222 of one of the header studs 220 is in abutting contact with the web 222 of the other header stud 220 as shown in FIG. 32. In one embodiment, the webs 222 may be interconnected by fasteners such as screws 892 or the like. See FIG. 33.

A pair of connector plates 810 is used on each end of the header assembly 1100 to attach the header assembly 1100 to the corresponding jamb stud 50. Fasteners 892 such as 10-16 screws, etc. are inserted through the holes in the connector plate 812 of the connectors 810. FIG. 32 illustrates use of fasteners 892 through all of the holes in the upper two rows 830, 840 of holes and the lower two rows 832, 842 of holes in the connector plate 812. The reader will appreciate that the number and types of fasteners 892 employed may vary depending upon the load capacity desired and the corresponding hole shapes that must be filled with a corresponding fastener 892. The locator tab 890 when abutted against the jamb stud 50 serves to locate the columns 866 and 868 along the jamb stud 50 for attachment of the plate 812 thereto. The header studs 220 in this embodiment may or may not be attached to each other by other fasteners (screws) or by welding. In those embodiments wherein the header studs 220 are not attached to each other, they are simply sandwiched together at their respective ends between the corresponding pairs of connectors 810.

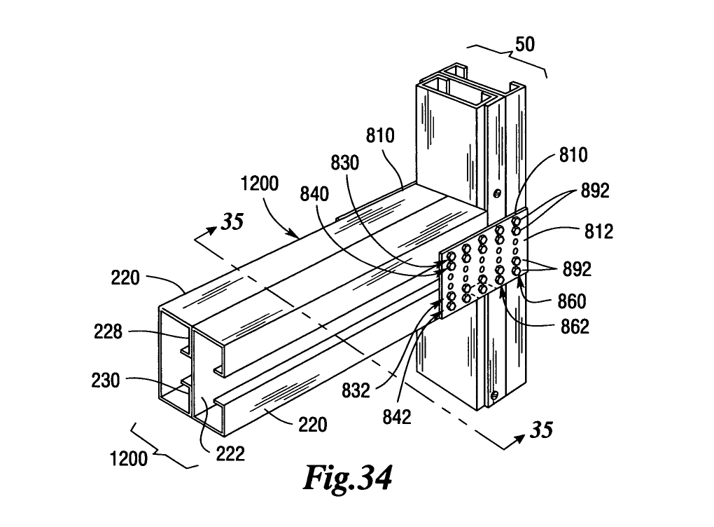

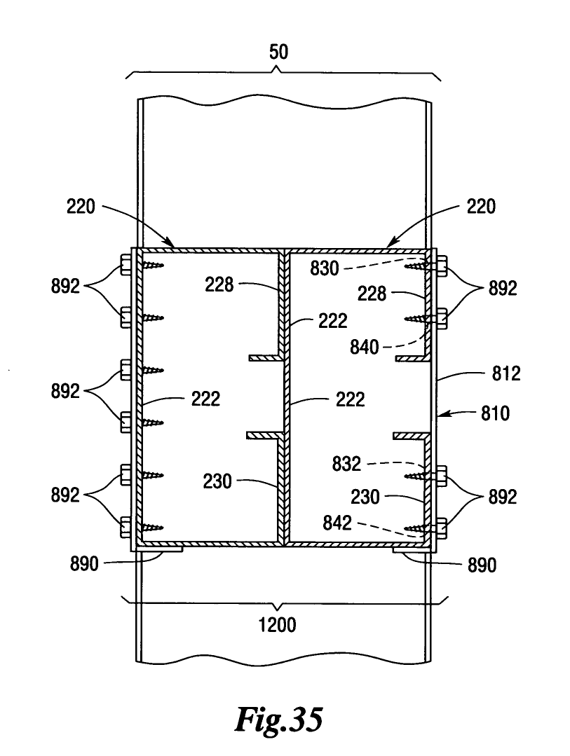

FIGS. 34 and 35 illustrate the use of the connector plates 810 of the subject invention in connection with an alternative header assembly 1200 of the present invention which also employs a pair of header studs 220 of the type and construction described above. In this embodiment, the first leg 228 and the second leg 230 of one of the header studs 22 are in abutting contact with the web 222 of the other header stud 220 as shown in FIGS. 34 and 35.

A pair of connector plates 810 is used on each end of the header assembly 1200 to attach the header assembly 1200 to the corresponding jamb stud 50. Fasteners 892 such as 10-16 screws, etc. are inserted through the holes in the connector plate 812 of the connectors 810. FIG. 35 illustrates use of fasteners 892 through all of the holes in the connection plate 812 that is abutted against the web 222 of one of the header studs 220. That Figure also illustrates fasteners 892 through all of the holes in the upper two rows 830, 840 of holes and the lower two rows 832, 842 of holes in the connector plate 812 that is abutted against the first leg 228 and the second leg 230 of the other header stud 220. The reader will appreciate that the number and types of fasteners 892 employed may vary depending upon the load capacity desired and the corresponding hole shapes that must be filled with a corresponding fastener 892. The locator tab 890, when abutted against the jamb stud 50, serves to locate the columns 866 and 868 along the jamb stud 50 for attachment of the plate 812 thereto. The header studs 220 in this embodiment may or may not be attached to each other by other fasteners (screws) or by welding. In those embodiments wherein the header studs 220 are not attached to each other, they are simply sandwiched together at their respective ends between the corresponding pairs of connectors 810.

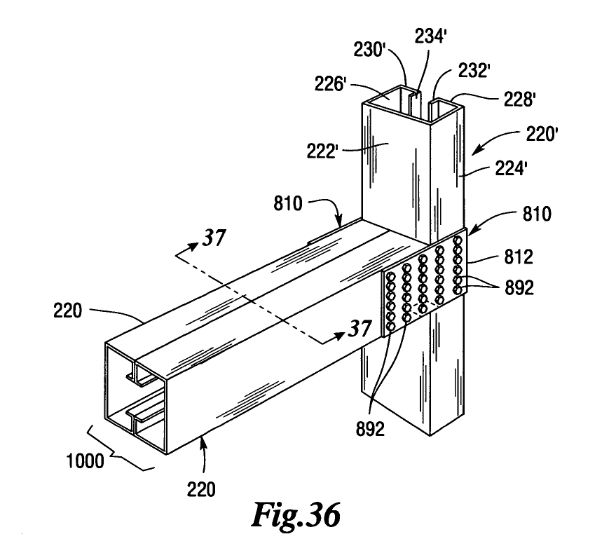

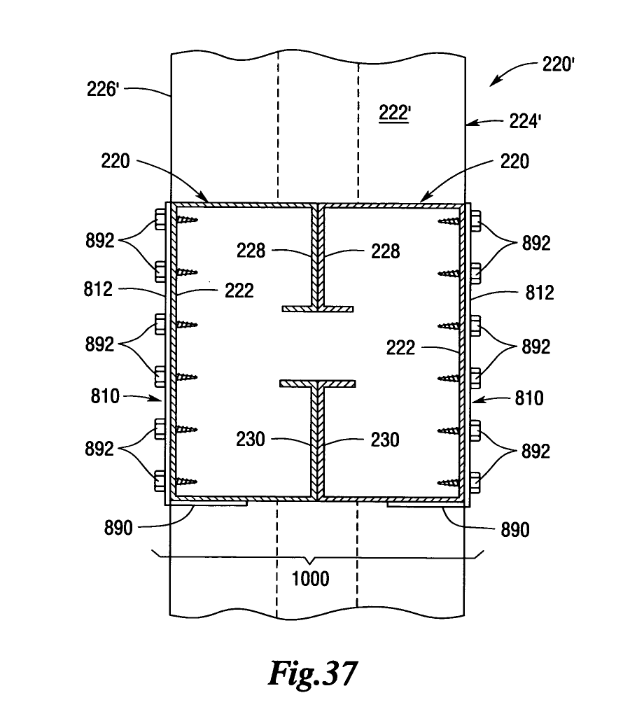

FIGS. 36 and 37 illustrate use of an embodiment of the connector plates 810 of the present invention to connect an end of a header assembly 1000 of the type and construction described above to a jamb stud 220′ embodiment of the present invention. As can be seen in those Figures, the header assembly 1000 includes a pair of header studs 220 that are arranged such that the first leg 228 of one header stud 220 is in abutting contact with the first leg 228 of the other header stud 220. Likewise, the second leg 230 of the one header stud 220 is in abutting contact with the second leg 230 of the other header stud 220. As was described above, an embodiment of the jamb stud 220′ has a substantially planar jamb stud web 222′, a first jamb stud flange 224′ and a second jamb stud flange 226′ that protrude from the jamb stud web 222′. A first jamb stud leg 228′ is attached or otherwise formed on the first jamb stud flange 224′ and a second jamb stud leg 230′ is formed on or attached to the second jamb stud flange 226′. A first jamb stud return 232′ is formed on the end of the first jamb stud leg 228′ and a second jamb stud return 234′ is formed on the end of the second jamb stud leg 230′.

A pair of connector plates 810 is used on each end of the header assembly 1000 to attach one end of the header assembly 1000 to the corresponding jamb stud 220′. Fasteners 892 such as 10-16 screws, etc. are inserted through the holes in the connector plate 812 of the connectors 810. FIGS. 30 and 31 illustrate use of fasteners 892 through all of the holes in the connector plate 812. The reader will appreciate that the number and types of fasteners 892 employed may vary depending upon the load capacity desired and the corresponding hole shapes that must be filled with a corresponding fastener 892. The locator tab 890 when abutted against the web 222′ of the jamb stud 220′ serves to locate the columns 866 and 868 of holes through the connector plate 812 along one of the corresponding the flanges 224′, 226′ (whatever the case may be) of the jamb stud 220′ for attachment of the plate 812 thereto. The header studs 220 in this embodiment may or may not be attached to each other by other fasteners (screws) or by welding. In those embodiments wherein the header studs 220 are not attached to each other, they are simply sandwiched together at their respective ends between the corresponding pairs of connectors 810.

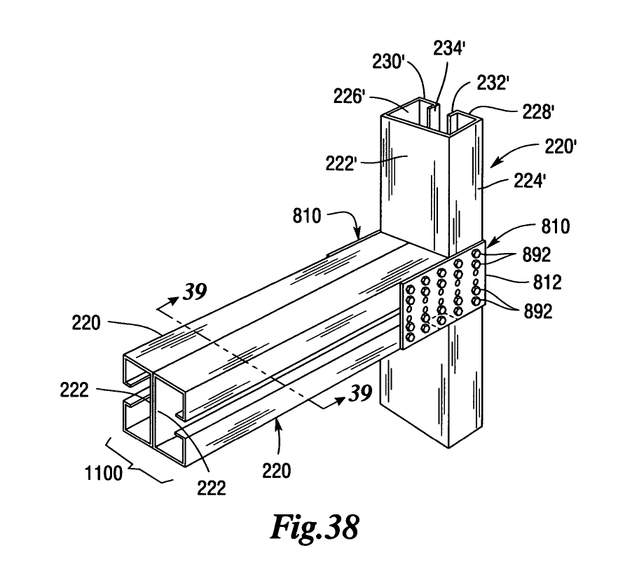

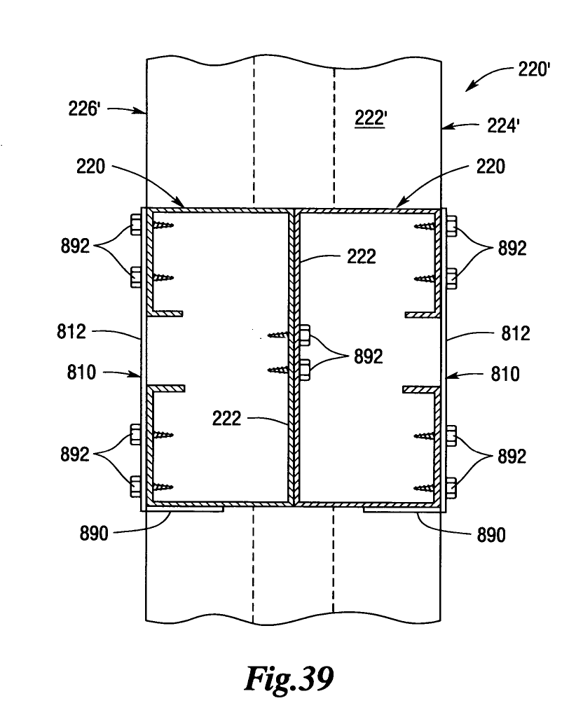

FIGS. 38 and 39 illustrate use of an embodiment of the connector plates 810 of the present invention to connect an end of a header assembly 1100 of the type and construction described above to a jamb stud 220′ embodiment of the present invention. As can be seen in those Figures, the header assembly 1100 includes a pair of header studs 220 that are arranged such that the web 222 of one header stud 220 is in abutting contact with the web 222 of the other header stud 220. As was described above, an embodiment of the jamb stud 220′ has a substantially planar jamb stud web 222′, a first jamb stud flange 224′ and a second jamb stud flange 226′ that protrude from the jamb stud web 222′. A first jamb stud leg 228′ is attached or otherwise formed on the first jamb stud flange 224′ and a second jamb stud leg 230′ is formed on or attached to the second jamb stud flange 226′. A first jamb stud return 232′ is formed on the end of the first jamb stud leg 228′ and a second jamb stud return 234′ is formed on the end of the second jamb stud leg 230′.

A pair of connector plates 810 is used on each end of the header assembly 1100 to attach one end of the header assembly 1100 to the corresponding jamb stud 220′. Fasteners 892 such as 10-16 screws, etc. are inserted through the holes in the connector plate 812 of the connectors 810.

FIGS. 38 and 39 illustrate use of fasteners 892 through all of the holes in the upper two rows and lower two rows of holes in the connector plate 812. The reader will appreciate that the number and types of fasteners 892 employed may vary depending upon the load capacity desired and the corresponding hole shapes that must be filled with a corresponding fastener 892. The locator tab 890 when abutted against the web 222′ of the jamb stud 220′ serves to locate the columns 866 and 868 of holes through the connector plate 812 along one of the corresponding the flanges 224′, 226′ (whatever the case may be) of the jamb stud 220′ for attachment of the plate 812 thereto. The header studs 220 in this embodiment may or may not be attached to each other by other fasteners (screws) or by welding. In those embodiments wherein the header studs 220 are not attached to each other, they are simply sandwiched together at their respective ends between the corresponding pairs of connectors 810.

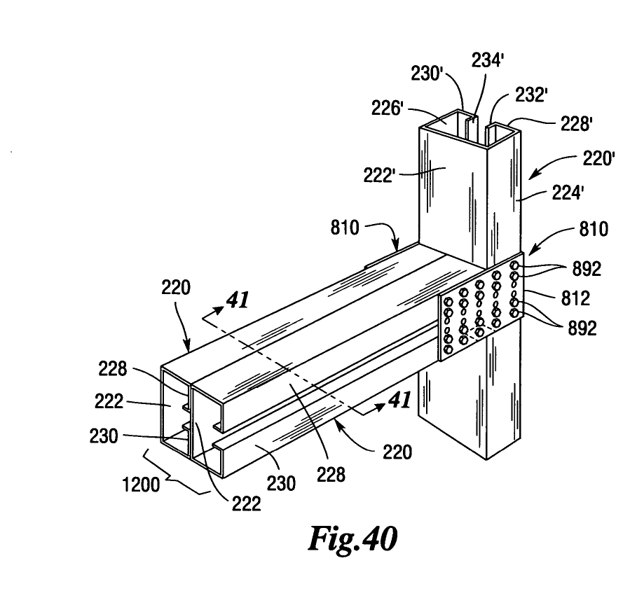

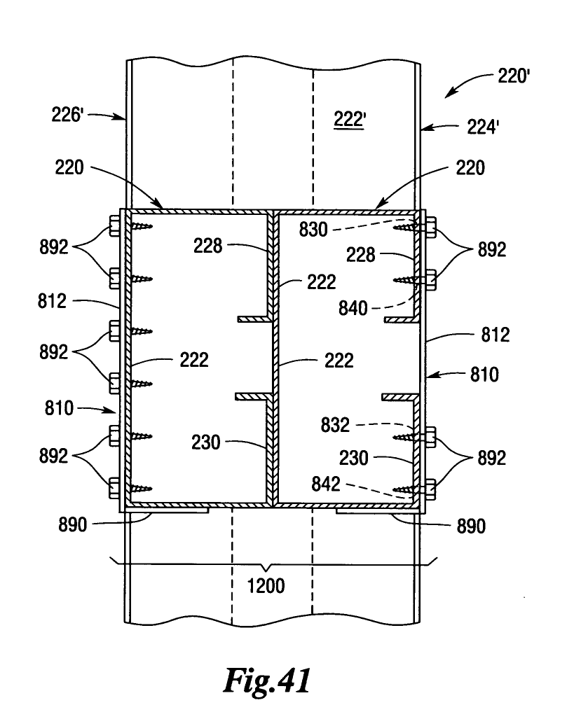

FIGS. 40 and 41 illustrate use of an embodiment of the connector plates 810 of the present invention to connect an end of a header assembly 1200 of the type and construction described above to a jamb stud 220′ embodiment of the present invention. As can be seen in those Figures, the header assembly 1200 includes a pair of header studs 220 that are arranged such that the first leg 228 and the second leg 230 of one header stud is in abutting contact with the web 222 of the other header stud 220. As was described above, an embodiment of the jamb stud 220′ has a substantially planar jamb stud web 222′, a first jamb stud flange 224′ and a second jamb stud flange 226′ that protrude from the jamb stud web 222′. A first jamb stud leg 228′ is attached or otherwise formed on the first jamb stud flange 224′ and a second jamb stud leg 230′ is formed on or attached to the second jamb stud flange 226′. A first jamb stud return 232′ is formed on the end of the first jamb stud leg 228′ and a second jamb stud return 234′ is formed on the end of the second jamb stud leg 230′.

A pair of connector plates 810 is used on each end of the header assembly 1200 to attach one end of the header assembly 1200 to the corresponding jamb stud 220′. Fasteners 892 such as 10-16 screws, etc. are inserted through the holes in the connector plate 812 of the connectors 810.

FIG. 41 illustrates use of fasteners 892 through all of the holes in the connection plate 812 that is abutted against the web 222 of one of the header studs 220. That Figure also illustrates fasteners 892 through all of the holes in the upper two rows and lower two rows of holes in the connector plate 812 that is abutted against the first leg 228 and the second leg 230 of the other header stud 220. The reader will appreciate that the number and types of fasteners 892 employed may vary depending upon the load capacity desired and the corresponding hole shapes that must be filled with a corresponding fastener 892. The locator tab 890 when abutted against the web 222′ of the jamb stud 220′ serves to locate the columns 866 and 868 of holes through the connector plate 812 along one of the corresponding the flanges 224′, 226′ (whatever the case may be) of the jamb stud 220′ for attachment of the plate 812 thereto. The header studs 220 in this embodiment may or may not be attached to each other by other fasteners (screws) or by welding. In those embodiments wherein the header studs 220 are not attached to each other, they are simply sandwiched together at their respective ends between the corresponding pairs of connectors 810.

The reader will appreciate that a variety of other connectors could also be employed to couple the various header assemblies 1000, 1100, 1200 described above to convention jamb stud assemblies 50 or to jamb studs 220′ of the types described herein without departing from the spirit and scope of the present invention.

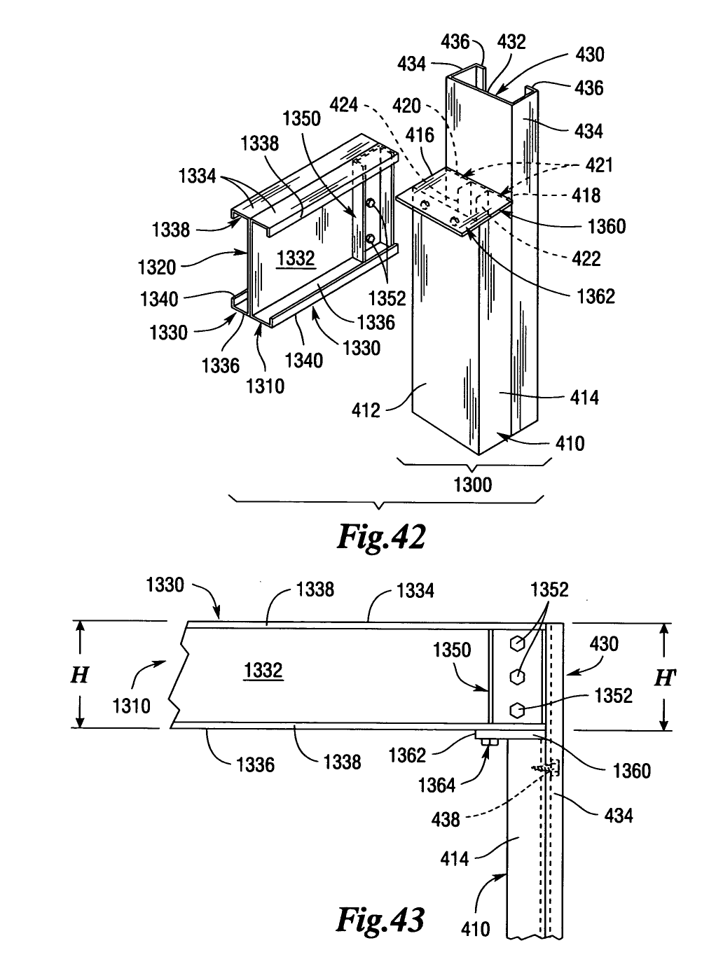

FIGS. 42 and 43 illustrate a load bearing jack post assembly 1300 that employs a post stud 410 described above and depicted in FIG. 19. The post stud 410 has a substantially planar post stud web 412 and a first post stud flange 414 and a second post stud flange 416 protruding from the post stud web 412. A first post stud leg 418 protrudes from the first post stud flange 414 and a second post stud leg 420 protrudes from the second post stud flange 416. A first post stud return 422 is formed on the end of the first post stud leg 418 and a second post stud return 424 is formed on the end of the second post stud leg 420. See FIG. 19.

In this embodiment, the post stud 410 is used in connection with a single stud 430. The stud 430 has a web 432 and two flanges 434. A lip 436 is formed on the end of each flange 434. The first and second post stud legs 416 and 420 are attached to the web 432 of the stud 430 by screws 421 and/or by welding. In the embodiment shown in FIGS. 42 and 43, the load bearing jack post assembly 1300 is used in connection with a header assembly 1310 that comprises an I-section header 1320.

The header 1320 may comprise a separately fabricated I-beam beam or it may be fabricated from two joists 1330 that are interconnected in back-to-back fashion. The reader will appreciate that in such arrangement, each joist 1330 has a web portion 1332 and an upper flange 1334 and a lower flange 1336 that protrude from the web portion 1332. An upper return 1338 is formed on the end of the upper flange 1334 and a lower return 1340 is formed on the end of the lower flange 1336. The web portions 1332 are arranged in back-to-back fashion and may be attached to each other by welding or other suitable fasteners such as screws. A conventional C-shaped web stiffener 1350 may be affixed to the web portion 1332 of one or both of the joists 1330 as shown to reinforce the I-section with a collection of screws 1352 such as No. 10-16 screws or the like.

The end of the header assembly 1310 is arranged to be supported on a bearing plate 1360 that is supported on the upper end of the post stud 410. In one embodiment, the bearing plate 1360 comprises a steel plate and is sized to completely cover the upper end of the post stud 410 and protrude therefrom to form a header attachment portion 1362 that cantilevers therefrom. The bearing plate 1360 is constructed to be welded to the end of the post stud 410 and/or the stud 430. The end of the header assembly 1310 is then supported on the bearing plate 1360 and attached thereto by welding or screws 1364.

The header assembly 1320 has a height “H” and the stud 430 extends beyond the end of the post stud 410 a distance “H” that is substantially equivalent to the height of the header assembly 1320. See FIG. 43. The assembly 1300 is formed by attaching the web 432 of the stud 430 to the post stud web 412 of the post stud 410 with fasteners 438 such as sheet metal screws or the like and the web 432 of the other stud 430 is attached to the first and second post stud legs (418, 420) of the post stud 410 by sheet metal screws 438 or the like. I have discovered that such arrangement provides an equivalent amount of structural support as prior post arrangements that employ three conventional studs and two pieces of conventional track. Thus, this embodiment of the present invention reduces the amount of material needed and also the amount of labor needed to assemble it when compared to prior post assemblies. It will be appreciated, however, that the post stud 410 may also be used in connection with one stud 430 or more than two studs 430 without departing from the spirit and scope of the present invention.

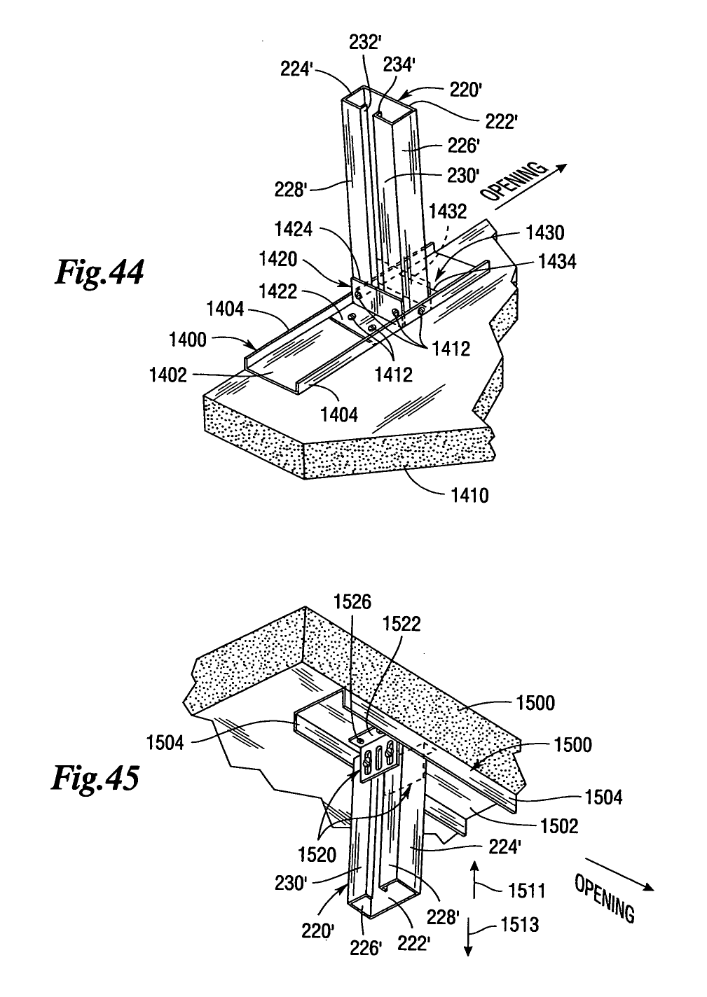

FIG. 44 illustrates one method for attachment of a jamb stud 220′ of the type and construction described above to a conventional section of bottom track 1400. The bottom track has a web 1402 and a pair of upstanding flanges 1404. The web 1402 of the bottom track 1400 is attached to floor decking 1410 or other support structure. The floor decking 1410 illustrated in FIG. 44 comprises concrete material. However, other types of floor decking materials may be employed. The web 1402 is attached to the floor decking material utilizing appropriate conventional fasteners.

As can be seen in FIG. 44, the bottom end of the jamb stud 220′ is received between the upstanding flanges 1404 and the flanges 224′ and 226′ may be attached to the upstanding flanges 1404 by fasteners 1412 and/or by welding. In one embodiment, fasteners 1412 comprise No. 10-16 screws. However other suitable fasteners could be employed. To further support the end of the jamb stud 220′ and attach it to the bottom track 1400, an L-shaped clip angle 1420 may be employed. In one embodiment, the clip angle 1420 has a first leg 1422 that is attached to the web 1402 of the bottom track 1400 and a second leg 1424 that is attached to the first leg 224′ and the second leg 226′ of the jamb stud 220′ by fasteners 1412 and/or by welding.

To provide additional support to the jamb stud 220′, a second L-shaped clip angle 1430 is employed. The clip angle 1430 may be identical to the clip angle 4120 and have a first leg 1422 that is attached to the web 1402 of the bottom track 1400 and a second leg 1434 that is attached to the web 222′ of the jamb stud 220′ by fasteners 1412 and/or by welding. The reader will also understand that the upper end of the jamb stud 220′ may be attached to an upper track (not shown) in a similar manner.

FIGS. 45 and 47 illustrate another method of attaching a jamb stud 220′ to a conventional upper track 1500 that is attached to a support structure 1506. The upper track 1500 has a web 1502 and a pair of upstanding flanges 1504. The web 1502 is attached to the support structure 1506 (concrete, steel or wood framing, etc.) utilizing appropriate conventional fasteners. The method and components illustrated in FIG. 45 serves to affix the end of the jamb stud 220′ to the upper track 1500 such that it can move relative to the upper track 1500 in the directions illustrated by arrows 1511 and 1513.

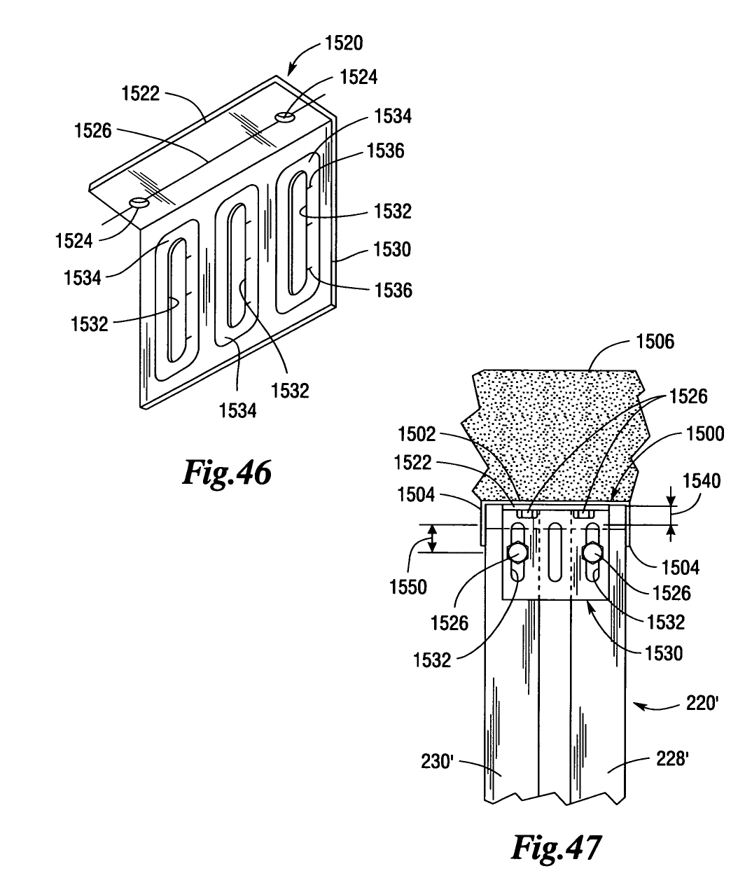

More particularly and with reference to FIGS. 45-47, in this embodiment, the upper end of the jamb stud 220′ is attached to the upper track 1500 utilizing a slotted bracket 1520 which may be of the type disclosed in U.S. Pat. No. 6,688,069 to Zadeh, the disclosure of which is herein incorporated by reference. As can be seen in FIGS. 46 and 47, one embodiment of the bracket 1520 includes a first connector plate 1522 and a second connector plate 1530 that forms a right angle juncture with the first connector plate 1522. The first connector plate 1522 may be provided with prepunched fastener holes 1524 and/or it may be provided with a score line 1526 and/or dimples (not shown) for locating fasteners as described in the above-mentioned patent. In one embodiment, the first connector plate 1522 is attached to the web 1502 of the upper track 1500 by fasteners 1526. In one embodiment, fasteners 1526 may comprise No. 10-16 screws or other appropriate fasteners.

In this embodiment, the second connector plate 1530 is provided with at least one and preferably at least two vertically extending slots 1532. The slots 1532 may be provided in embossed stiffener regions 1534 and fastener locating indicia 1536 may also be provided adjacent each slot 1532. As can be seen in FIG. 47, a fastener 1526 is installed through one slot 1532 into the leg 228′ of the jamb stud 220′ and another fastener 1526 is provided through another slot 1532 into the leg 230′. To achieve the desired amount of vertical deflection, the slots 1532 may be provided such that the upper ends of the slots 1532 are located a first distance 1540 from the web 1502 of the upper track 1500 when the bracket 1520 is installed as shown in FIG. 47 and the fasteners 1526 may be located a second distance 1550 away from the upper ends of the slots 1532. See FIG. 47.

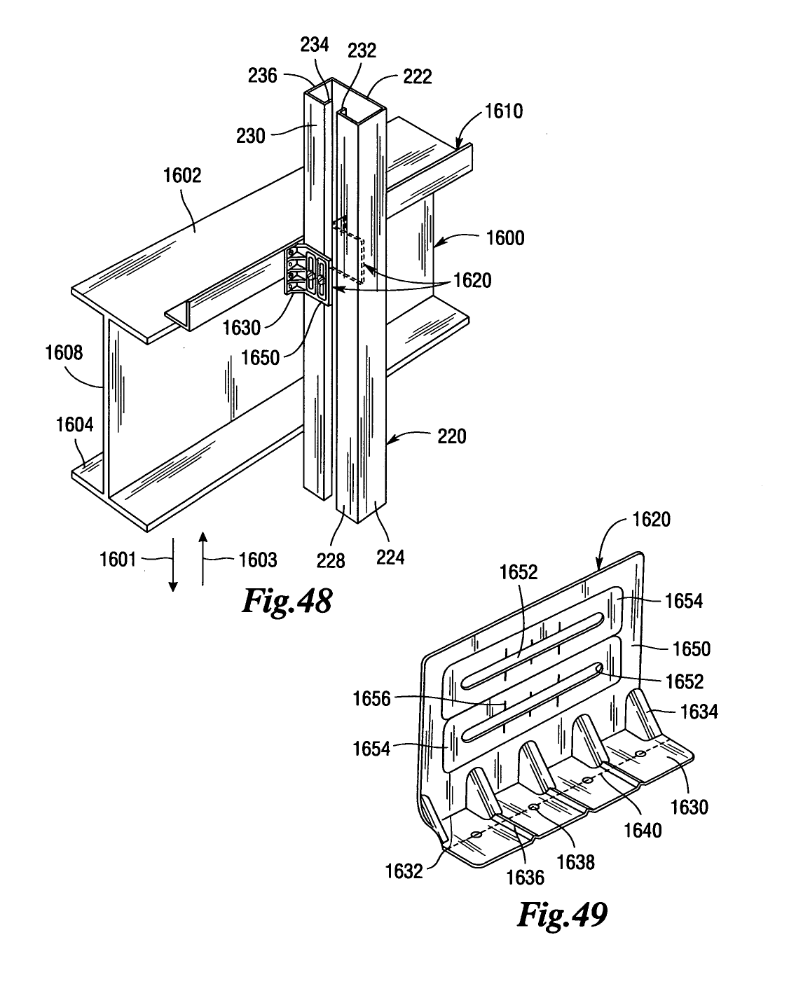

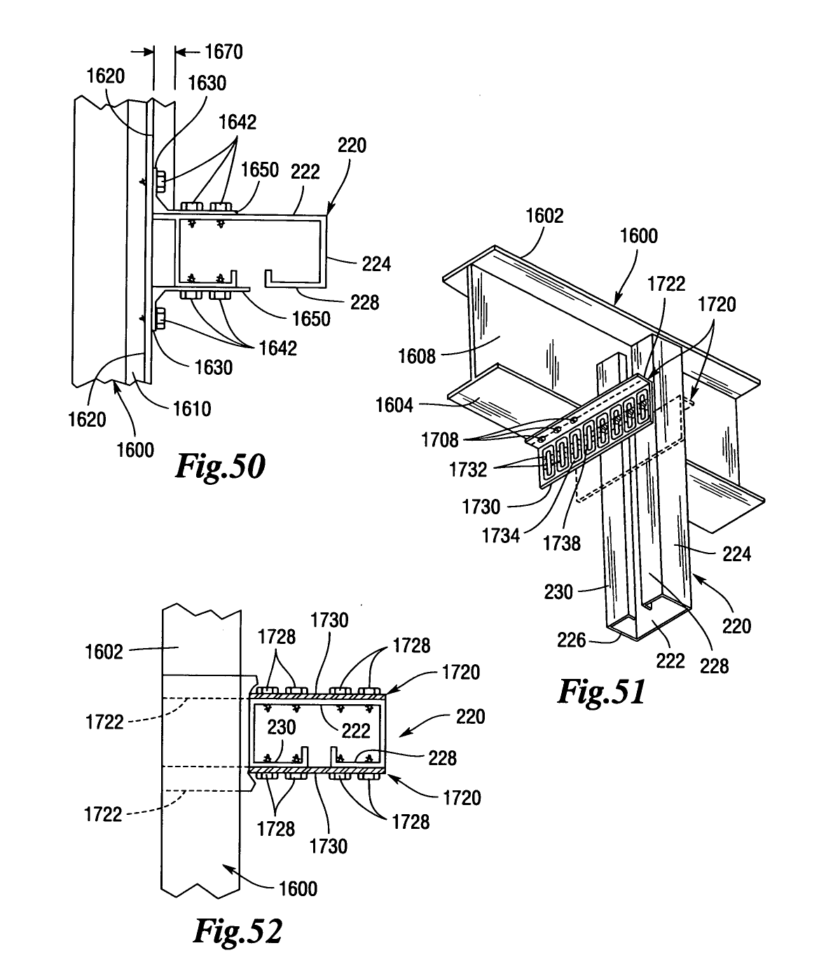

FIGS. 48 and 50 illustrate one method of attaching a stud 220 of the type and construction described above to an I beam 1600 or other structure such that the stud 220 can move relative to the I beam 1600 in the directions represented by arrows 1601 and 1603. The I beam 1600 may comprise a conventional I beam that has an upper flange 1602 and a lower flange 1604 that are interconnected by a web 1608. In one embodiment, the stud 220 may be affixed to the I beam 1600 by a piece of conventional angle 1610 that is welded to or otherwise attached to the I beam 1600 and a connection bracket 1620 of the type described in U.S. Pat. No. 6,688,069.

As shown in FIG. 49, the bracket 1620 has a first connector plate 1630 and a second connector plate 1650 that is arranged relative to the first connector plate 1630 to form a right angled juncture 1632 therewith. At least one stiffener channel 1634 may be formed in the right angled juncture 1632 to stiffen the bracket 1620. Also, one or more linear stiffener channels 1636 may be provided in the first connector plate 1630. A plurality of fastener locating dimples or holes 1638 and/or a score line 1640 may be provided in the first connector plate 1630 to assist the installer with positioning the fastener screws 1642.

The second connector plate 1650 is provided with at least one and preferably at least two slots 1652 that each may be located within an embossed stiffener region 1654. Fastener locating indicia 1656 may be provided in one or more stiffener regions. The bracket 1620 is then attached to the leg 230 of the stud with fastener screws 1642 that are installed through the slots 1652 and into the leg 230. As can be seen in FIG. 50, a second bracket 1620 may be attached to the web 222 of the stud 220 by screws 1642 extending through the slots 1652 in the bracket 1620. As can be seen in FIG. 50, in one embodiment, a gap 1670 is provided between the leg 226 of the stud 220 and the upstanding leg of the angle 1610. In one embodiment, that gap 1670 may be a maximum of one inch. Other gap sizes may be employed depending upon the application.

FIGS. 51 and 52 illustrate the slidable attachment of a stud 220 to the lower flange 1604 of an I beam 1600 utilizing brackets 1720 that are somewhat longer and have more slots than bracket 1620. Bracket 1720 is essentially identical to bracket 1620 except that, in the embodiment depicted in FIGS. 51 and 52, the bracket 1720 lacks the stiffener channels 1634 and 1636 and it may have more slots. It will be understood, however, that bracket 1720 may be formed with stiffener channels similar to those in bracket 1620 without departing from the spirit and scope of the present invention. As can be seen in FIG. 51, the bracket 1720 has a first connector plate 1722 and a second connector plate 1730 that is oriented at a right angle with respect to the first connector plate 1722. In the embodiment depicted in FIG. 51, the first connector plate 1722 is provided with a score line 1724 to assist the installer in locating fasteners 1728 for connecting the first connector plate 1722 to the lower flange 1604 of the I-beam 1600. However, the first connector plate 1722 may be provided with prepunched holes and/or dimples.

The second connector plate 1730 is provided with a plurality of slots 1732 that may each be located in a corresponding embossed stiffener region 1734. Fastener locating indicia 1738 may be associated with one or more slots 1732 may be provided in the second connector plate 1730. As can be seen in FIG. 52, the second connector plate 1730 is attached to the first and second legs 228, 230 by screws or other suitable fasteners 1728 extending through the slots 1732 corresponding thereto. A second bracket 1720 may be employed and attached to the web 222 of the stud 220 with fasteners 1728 as illustrated in FIG. 52.

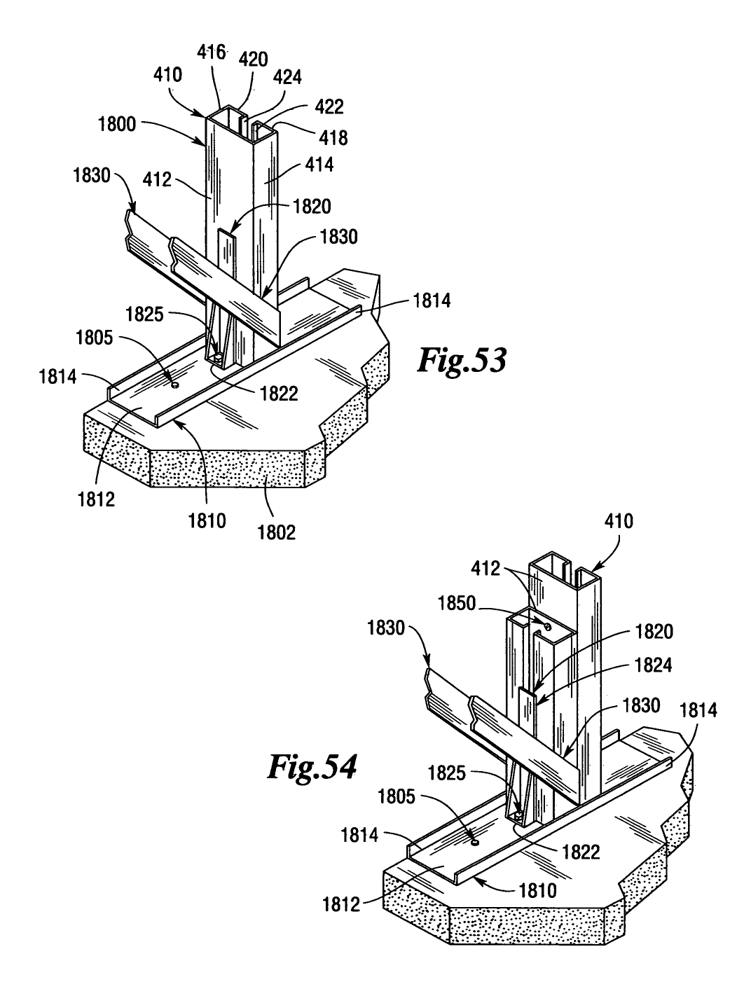

FIG. 53 illustrates a shearwall post arrangement 1800 that employs a post stud 410 of the type and construction described above. As can be seen in that Figure, the bottom end of the post stud 410 is supported on and attached to a conventional bottom track 1810 that has a web 1812 and a pair of upstanding flanges 1814. The bottom end of the post stud 410 may be attached to the flanges 1814 of the bottom track 1810 by welding or other suitable fastening means. The bottom track 1810 may be attached to the floor structure 1802 by conventional fasteners 1805 such as, for example, conventional shear anchors or the like.

To provide additional support to the post stud 410, a device 1820 known in the industry as a “hold-down” may be employed. In on embodiment, the hold-down 1820 has a base portion 1822 and a vertically extending strut portion 1824 that is arranged at a right angle to the base portion 1822. The strut portion 1824 is attached to the web 412 of the post stud 410 by welding or other suitable fastening means. The base portion 1822 is configured to receive a bolt 1825 or other suitable fastener for attaching the base portion 1822 to the underlying floor structure 1802. In addition, depending upon the application, a strap 1830 or straps 1830 may be attached to the post stud 410 and/or hold-down 1820. In one embodiment, the straps are metal and welded to the hold-down 1820 and the post stud 410.

FIG. 54 illustrates the use of two post studs 410 in back-to back relationship to form another shearwall post embodiment of the present invention. In this embodiment, the webs 412 of the post studs 410 may be attached by a series of appropriately sized fasteners 1850 or the post studs 410 may be welded together. In one embodiment, No. 10-16 screws, spaced 12 inches on center, are employed to affix the webs 412 of the post studs 410 together. The posts studs 410 are attached to the flanges 1814 of the base track 1810 by suitable fasteners or by welding. A hold-down 1820 of the type and construction described above may be attached to one of the post studs 410 by welding and bolted to the floor structure 1802 with a suitable anchor bolt 1825. One or more straps 1830 may be welded or other wise attached to the post studs 410.

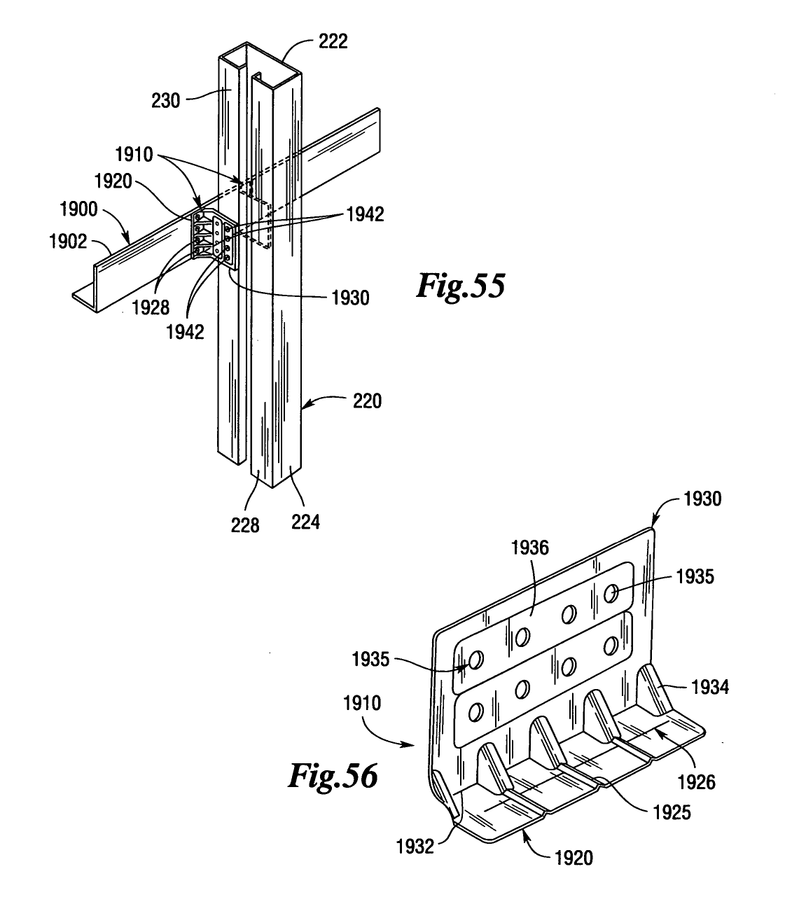

FIG. 55 illustrates the attachment of a stud 220 of the present invention attached to a structure such as a piece of angle 1900 that may be affixed to other structures such as I beams, girders, posts, etc. (not shown). In this embodiment, at least one, and preferably two, connector brackets 1910 which may be of the type disclosed in U.S. Pat. No. 6,688,069 to Zadeh are used to rigidly affix the stud 220 to the angle 1900.

As can be seen in FIG. 56, one embodiment of the bracket 1910 includes a first connector plate 1920 and a second connector plate 1930 that forms a right angle juncturel 932 with the first connector plate 1920. At least one stiffener channel 1934 may be formed in the right angled juncture 1932 to stiffen the bracket 1910. Also, one or more linear stiffener channels 1925 may be provided in the first connector plate 1920. The first connector plate 1920 may be provided with prepunched fastener holes and/or it may be provided with a score line 1926 and/or dimples (not shown) for locating fasteners as described in the above-mentioned patent. In one embodiment, the first connector plate 1920 is attached to the leg 1902 of the angle 1900 by fasteners 1928. In one embodiment, fasteners 1928 may comprise No. 10-16 screws or other appropriate fasteners.

The second connector plate 1930 is provided with at least one row 1932 of fastener holes 1935 therethrough. The row 1932 of fasteners holes 1934 may be located within an embossed stiffener region 1936. The bracket 1910 is then attached to the leg 230 of the stud 220 with fastener screws 1942 that are installed through the holes 1934 and into the leg 230. As can be seen in FIG. 55, a second bracket 1910 may be attached to the web 222 of the stud 220 by screws 1942 extending through the fastener holes 1935 in the bracket 1910.

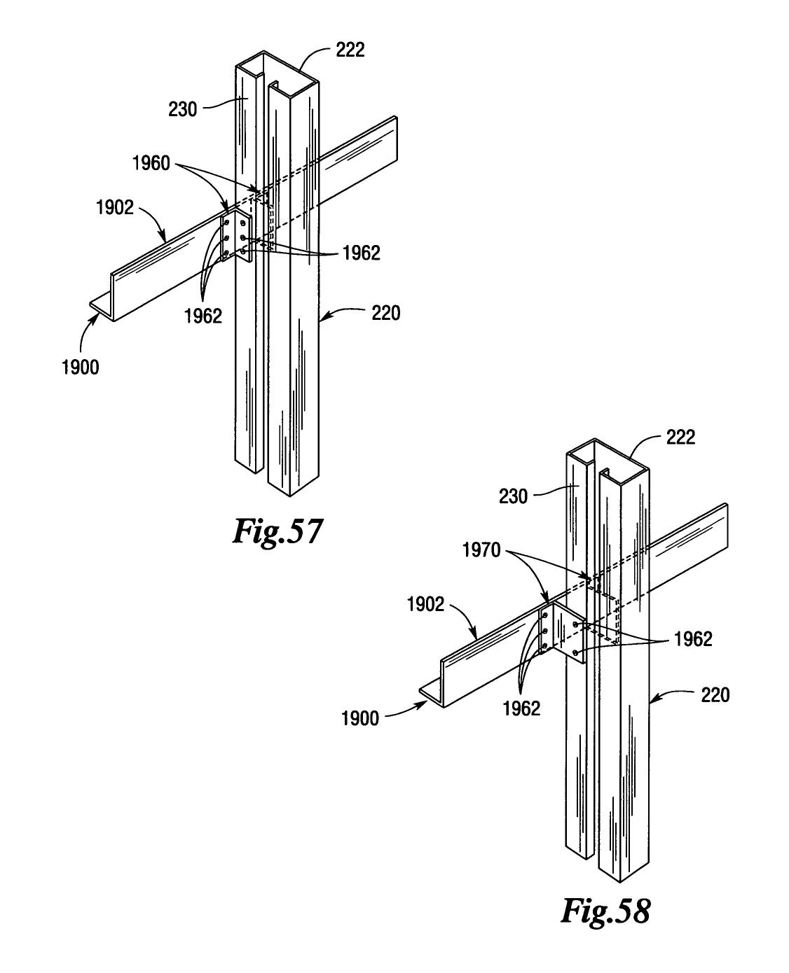

FIG. 57 illustrates non-movable attachment of a stud 220 to the angle 1900 by an angle clip 1960 that is affixed to the angle 1900 and the leg 230 of the stud 220 by fasteners 1962 and/or by welding. Also in this embodiment, a second angle clip 1960 may be attached to the leg 1902 of the angle 1900 and the web 222 of the stud 222 by fasteners 1962 and/or by welding.

FIG. 58 illustrates non-movable attachment of a stud 220 to the angle 1900 by another angle clip 1970 that is affixed to the angle 1900 and the leg 230 of the stud 220 by fasteners 1972 and/or by welding. Also in this embodiment, a second angle clip 1970 may be attached to the leg 1902 of the angle 1900 and the web 222 of the stud 222 by fasteners 1972 and/or by welding.

As can be appreciated from the foregoing description, the unique and novel header assemblies and connection plates of the present invention may have a variety of advantages over prior header arrangements and connectors. The unique and novel connector of the present invention eliminates the need for “left” and “right” connectors for attaching header assemblies to jamb studs or when connecting other types of components. In addition, the unique fastener hole arrangement employed in such connector plates enables the installer to easily attain the desired load capacity for the connection. The reader will also appreciate the connectors of the subject invention may be employed with conventional headers and jamb studs. It will be further appreciated that the connectors of the present invention may also be used to connect wooden header arrangements to wood jamb studs or, if desired, to connect a metal header assembly to a wooden jamb stud or a wooden header to a metal jamb stud. The various embodiments of the subject invention depicted in FIGS. 30-58 may also be constructed utilizing studs 620 of the type and construction described above.

The present invention also addresses the problems associated with fabricating headers from metal or the like. The unique and novel header assemblies of the present invention may be quickly assembled together without the need to employ several pieces of studs and track and fasteners to couple them together. In applications wherein it is desirable to install insulation inside of the header assemblies, the installer should find it easier to install insulation in at least some of the header assemblies of the present invention when compared to installing insulation in prior header arrangements.

The invention which is intended to be protected is not to be construed as limited to the particular embodiments disclosed. The embodiments are therefore to be regarded as illustrative rather than restrictive. Variations and changes may be made by others without departing from the spirit of the present invention. Accordingly, it is expressly intended that all such equivalents, variations and changes which fall within the spirit and scope of the present invention as defined in the claims be embraced thereby.

What is claimed is:

1. A header and jamb stud arrangement comprising:
a jamb stud assembly comprising:
a jamb stud comprising:
a substantially planar jamb stud web;
a first jamb stud flange protruding from said substantially planar jamb stud web;
a second jamb stud flange protruding from said substantially planar jamb stud web and being spaced from said first jamb stud flange;
a first jamb stud leg protruding from said first jamb stud flange and being substantially parallel to said substantially planar jamb stud web;
a second jamb stud leg protruding from said second jamb stud flange and being substantially parallel to said substantially planar jamb stud web;
a first jamb stud return on an end of said first jamb stud leg; and
a second jamb stud return on an end of said second jamb stud leg; and
another jamb stud comprising:
another substantially planar jamb stud web, said another substantially planar jamb stud web adjacent to said substantially planar jamb stud web of said jamb stud;
another first jamb stud flange protruding from said another substantially planar jamb stud web;
another second jamb stud flange protruding from said another substantially planar jamb stud web and being spaced from said another first jamb stud flange;
another first jamb stud leg protruding from said another first jamb stud flange and being substantially parallel to said another substantially planar jamb stud web;
another second jamb stud leg protruding from said another second jamb stud flange and being substantially parallel to said another substantially planar jamb stud web;
another first jamb stud return on an end of said another first jamb stud leg; and
another second jamb stud return on an end of said another second jamb stud leg;
a third jamb stud supported in spaced-apart relationship with respect to said jamb stud assembly;
a first C-shaped connector attached to said jamb stud assembly, said first C-shaped connector having a pair of spaced first flanges defining a first header-receiving area therebetween;
a C-shaped track attached to a portion of said jamb stud assembly that is located beneath said first C-shaped connector;
a second C-shaped connector attached to said third jamb stud and having a pair of spaced second flanges defining a second header-receiving area therebetween; and
at least one header having a first end received in said first header-receiving area of said first C-shaped connector and a second end received in said second header-receiving area of said second C-shaped connector and spanning between said jamb stud assembly and said third jamb stud to define an upper boundary of an opening therebetween.

2. The header and jamb stud arrangement of claim 1 wherein at least one said header comprises:
a substantially planar header web;
a first header flange protruding from said substantially planar header web;
a second header flange protruding from said substantially planar header web and being spaced from said first header flange;
a first header leg protruding from said first header flange and being substantially parallel to said substantially planar header web;
a second header leg protruding from said second header flange and being substantially parallel to said substantially planar header web and substantially coplanar with said first header leg to define support surfaces spanning between said first and second vertically extending jamb studs;
a first header return on an end of said first header leg; and
a second header return on an end of said second header leg.

3. The header and jamb stud arrangement of claim 1 wherein said third jamb stud comprises a second jamb stud assembly that is identical to said jamb stud assembly.

4. The header and jamb stud arrangement of claim 2 further comprising at least one stiffener rib in at least one of said planar header web, said first header flange, said second header flange, said first header leg and said second header leg.

5. The header and jamb stud arrangement of claim 1 wherein at least one of said jamb stud and said another jamb stud has at least one stiffener rib therein.

6. A header and jamb stud arrangement comprising:
a first jamb stud;
a second jamb stud supported in spaced-apart relationship with respect to said first jamb stud;
a first C-shaped connector attached to said jamb stud assembly, said first C-shaped connector having a pair of spaced first flanges defining a first header-receiving area therebetween;
a second C-shaped connector attached to said third jamb stud and having a pair of spaced second flanges defining a second header-receiving area therebetween;
a first header having a first end received in said first header-receiving area of said first C-shaped connector and a second end received in said second header-receiving area of said second C-shaped connector and spanning between said first and second jamb studs; and
a second header adjacent to said first header and having one end thereof received in said first header-receiving area of said first C-shaped connector and another end thereof received in said second header-receiving area of said second C-shaped connector and spanning between said first and second jamb studs.

7. The header and jamb stud arrangement of claim 6 wherein at least one of said first and second headers comprises:
a substantially planar header web;
a first header flange protruding from said substantially planar header web;
a second header flange protruding from said substantially planar header web and being spaced from said first header flange;
a first header leg protruding from said first header flange and being substantially parallel to said substantially planar header web;
a second header leg protruding from said second header flange and being substantially parallel to said substantially planar header web and substantially coplanar with said first header leg to define support surfaces spanning between said first and second vertically extending jamb studs;
a first header return on an end of said first header leg; and
a second header return on an end of said second header leg.

8. The header and jamb stud arrangement of claim 6 wherein said first and second headers each comprise:
a substantially planar header web;
a first header flange protruding from said substantially planar header web;
a second header flange protruding from said substantially planar header web and being spaced from said first header flange;
a first header leg protruding from said first header flange and being substantially parallel to said substantially planar header web;
a second header leg protruding from said second header flange and being substantially parallel to said substantially planar header web and substantially coplanar with said first header leg to define support surfaces spanning between said first and second vertically extending jamb studs;
a first header return on an end of said first header leg; and
a second header return on an end of said second header leg.

9. The header and jamb stud arrangement of claim 6 wherein said first and second headers are fastened together.

10. The header and jamb stud arrangement of claim 8 wherein said substantially planar web of said first header is in abutting contact with said substantially planar web of said second header.

11. The header and jamb stud arrangement of claim 10 wherein said substantially planar web of said first header is attached to said substantially planar web of said second header.

12. The header and jamb stud arrangement of claim 8 wherein said first and second header legs of said second header are received on said substantially planar web of said first header.

13. The header and jamb stud arrangement of claim 6 wherein at least one of said first and second jamb studs comprises:
a substantially planar jamb stud web;
a first jamb stud flange protruding from said substantially planar jamb stud web;
a second jamb stud flange protruding from said substantially planar jamb stud web and being spaced from said first jamb stud flange;
a first jamb stud leg protruding from said first jamb stud flange and being substantially parallel to said substantially planar jamb stud web;
a second jamb stud leg protruding from said second jamb stud flange and being substantially parallel to said substantially planar jamb stud web;
a first jamb stud return on an end of said first jamb stud leg; and
a second jamb stud return on an end of said second jamb stud leg.

14. The header and jamb stud arrangement of claim 13 further comprising a stud attached to at least one of said first and second jamb studs.

15. The header and jamb stud arrangement of claim 14 wherein said stud is in abutting contact with said first and second jamb stud legs.

16. A truss assembly comprising:
a first truss chord comprising:
a substantially planar first truss cord web;
a first truss chord flange protruding from said substantially planar first truss chord web;
a second truss chord flange protruding from said substantially planar first truss chord web and being spaced from said first truss chord flange;
a first truss chord leg protruding from said first truss chord flange and being substantially parallel to said substantially planar first truss chord web;
a second truss chord leg protruding from said second truss chord flange and being substantially parallel to said substantially planar first truss chord web and substantially coplanar with said first truss chord leg;
a first truss chord return on an end of said first truss chord leg; and
a second truss chord return on an end of said second truss chord leg;
another truss chord comprising:
another substantially planar truss chord web;
another first truss chord flange protruding from said another substantially planar truss chord web;
another second truss chord flange protruding from said another substantially planar truss chord web and being spaced from said another first truss chord flange;
another first truss chord leg protruding from said another first truss chord flange and being substantially parallel to said another substantially planar truss chord web;
another second truss chord leg protruding from said another second truss chord flange and being substantially parallel to said another substantially planar truss chord web and substantially coplanar with said another first truss chord leg,
another first truss chord return on another end of said another first truss chord leg; and
another second truss chord return on another end of said another second truss chord leg, said another truss chord stud retained in abutting contact with said first truss chord to form a truss chord assembly; and
at least one web assembly attached to said truss chord assembly.

17. The truss assembly of claim 16 wherein said web assemblies are attached to the truss chord assembly by a pair of gusset plates that retain said another truss chord in abutting contact with said first truss chord.

18. The truss assembly of claim 16 wherein said first truss chord leg abuts said another first truss chord leg and wherein said second truss chord leg abuts said another second truss chord leg.

19. The truss assembly of claim 16 wherein said first truss chord web abuts said another truss chord web.

20. The truss assembly of claim 16 wherein said first and second truss chord legs of said first truss chord abut said another truss chord web.

21. The truss assembly of claim 16 wherein said first truss chord is welded to said another truss chord.

22. The truss assembly of claim 16 wherein at least one of said first truss chord and said another truss chord has at least one stiffener rib formed therein.

23. The truss assembly of claim 16 wherein at least one said web assembly comprises:
a first truss stud comprising:
a substantially planar first truss stud web;
a first truss stud flange protruding from said substantially planar first truss stud web;
a second truss stud flange protruding from said substantially planar first truss stud web and being spaced from said first truss stud flange;
a first truss stud leg protruding from said first truss stud flange and being substantially parallel to said substantially planar first truss stud web;
a second truss stud leg protruding from said second truss stud flange and being substantially parallel to said substantially planar first truss stud web and substantially coplanar with said first truss stud leg;
a first truss stud return on an end of said first truss stud leg; and
a second truss stud return on an end of said second truss stud leg;
another truss stud comprising:
another substantially planar truss stud web;
another first truss stud flange protruding from said another substantially planar truss stud web;
another second truss stud flange protruding from said another substantially planar truss stud web and being spaced from said another first truss stud flange;
another first truss stud leg protruding from said another first truss stud flange and being substantially parallel to said another substantially planar truss stud web;
another second truss stud leg protruding from said another second truss stud flange and being substantially parallel to said another substantially planar truss stud web and substantially coplanar with said another first truss stud leg;
another first truss stud return on another end of said another first truss stud leg; and
another second truss stud return on another end of said another second truss stud leg, said another truss stud retained in abutting contact with said first truss stud to form a web assembly.

24. A truss comprising:
an upper truss chord comprising:
a substantially planar first chord web;
a first chord flange protruding from said substantially planar first chord web;
a second chord flange protruding from said substantially planar first chord web and being spaced from said first truss chord flange;
a first chord leg protruding from said first chord flange and being substantially parallel to said substantially planar first chord web;
a second chord leg protruding from said second chord flange and being substantially parallel to said substantially planar first chord web and substantially coplanar with said first chord leg;
a first chord return on an end of said first chord leg; and
a second chord return on an end of said second chord leg;
another upper truss chord having an end in abutting contact with an end of said truss chord to form the peak of the truss, said another truss chord comprising:
another substantially planar chord web;
another first chord flange protruding from said another substantially planar chord web;
another second chord flange protruding from said another substantially planar chord web and being spaced from said another first chord flange;
another first chord leg protruding from said another first chord flange and being substantially parallel to said another substantially planar chord web;
another second chord leg protruding from said another second chord flange and being substantially parallel to said another substantially planar chord web and substantially coplanar with said another first chord leg;
another first chord return on another end of said another first chord leg; and
another second chord return on another end of said another second chord leg.

25. The truss of claim 24 wherein said upper chord and said other upper chord are interconnected by at least one gusset plate.

26. A truss supported between two support structures, comprising:
at least one first truss stud extending between the support structures and received thereon, said first truss stud comprising:
a substantially planar first truss stud web;
a first truss stud flange protruding from said substantially planar first truss stud web;
a second truss stud flange protruding from said substantially planar first truss stud web and being spaced from said first truss stud flange;
a first truss stud leg protruding from said first truss stud flange and being substantially parallel to said substantially planar first truss stud web;
a second truss stud leg protruding from said second truss stud flange and being substantially parallel to said substantially planar first truss stud web and substantially coplanar with said first truss stud leg;
a first truss stud return on an end of said first truss stud leg; and
a second truss stud return on an end of said second truss stud leg;
at least two other chord studs forming a peak of the truss and being coupled to said first truss stud, each said other chord stud comprising:
another substantially planar chord web;
a first chord flange protruding from said substantially planar chord web;
a second chord flange protruding from said substantially planar chord web and being spaced from said first chord flange;
a first chord leg protruding from said first chord flange and being substantially parallel to said substantially planar chord web;
a second chord leg protruding from said second chord flange and being substantially parallel to said substantially planar chord web and substantially coplanar with said first chord leg;
a first chord return on an end of said first chord leg; and
a second chord return on an end of said second chord.

27. A header and jamb stud arrangement comprising:
a header having two ends and a height;
a jamb stud corresponding to each end of said header, at least one said jamb stud comprising:
a substantially planar jamb stud web;
a first jamb stud flange protruding from said substantially planar jamb stud web;
a second jamb stud flange protruding from said substantially planar jamb stud web and being spaced from said first jamb stud flange;
a first jamb stud leg protruding from said first jamb stud flange and being substantially parallel to said substantially planar jamb stud web;
a second jamb stud leg protruding from said second jamb stud flange and being substantially parallel to said substantially planar jamb stud web;
a first jamb stud return on an end of said first jamb stud leg; and
a second jamb stud return on an end of said second jamb stud leg;
a bearing plate on an upper end of at least one said jamb stud for receiving an end of said header thereon; and
a stud attached to said jamb stud supporting said bearing plate and extending beyond said bearing plate a distance that substantially corresponds to said height of said header.

28. The header and jamb stud arrangement of claim 27 wherein said bearing plate has an attachment portion that protrudes outward from said jamb stud for attachment to said header.

29. The header and jamb stud arrangement of claim 27 wherein said header comprises an I beam.

30. The header and jamb stud arrangement of claim 29 further comprising a web stiffener attached to said I beam.

31. A jamb stud arrangement comprising:
a structure;
a track attached to said structure, said track having a web and a pair of flanges;
a jamb stud comprising:
a substantially planar jamb stud web;
a first jamb stud flange protruding from said substantially planar jamb stud web;
a second jamb stud flange protruding from said substantially planar jamb stud web and being spaced from said first jamb stud flange;
a first jamb stud leg protruding from said first jamb stud flange and being substantially parallel to said substantially planar jamb stud web;
a second jamb stud leg protruding from said second jamb stud flange and being substantially parallel to said substantially planar jamb stud web;
a first jamb stud return on an end of said first jamb stud leg; and
a second jamb stud return on an end of said second jamb stud leg; and
at least one L-shaped connector having a pair of legs, one said leg attached to said jamb stud and the other said leg attached to said track.

32. The jamb stud arrangement of claim 31 wherein said L-shaped connector slidably attaches said jamb stud to said track.

33. The jamb stud arrangement of claim 32 wherein at least one said L-shaped connector comprises:
a first connector plate attachable to said track; and
a second connector plate having at least one slot therethrough for receiving a fastener for coupling said second connector plate to said jamb stud.

34. The jamb stud arrangement of claim 33 wherein said second connector plate has at least two slots therein and wherein a first fastener extends through one said slot to engage said first jamb stud leg and wherein another fastener extends through the other slot to engage said second jamb stud leg.

35. The jamb stud arrangement of claim 33 wherein said fastener extends through said slot to engage said jamb stud web.

36. The jamb stud arrangement of claim 31 wherein said at least one L-shaped connectors comprises:
a first connector comprising:
a first connector plate attachable to said track; and
a second connector plate having a first slot therethrough for receiving a first fastener therethrough that engages said first jamb stud leg and a second slot for receiving a second fastener therethrough to engage said first jamb stud leg; and
a second connector comprising:
a first connector plate for attachment to said track; and
a second connector plate having at least one slot therein for receiving another fastener therethrough which engages said jamb stud web.

37. A jamb stud arrangement comprising:
a structure;
a jamb stud comprising:
a substantially planar jamb stud web;
a first jamb stud flange protruding from said substantially planar jamb stud web;
a second jamb stud flange protruding from said substantially planar jamb stud web and being spaced from said first jamb stud flange;
a first jamb stud leg protruding from said first jamb stud flange and being substantially parallel to said substantially planar jamb stud web;
a second jamb stud leg protruding from said second jamb stud flange and being substantially parallel to said substantially planar jamb stud web;
a first jamb stud return on an end of said first jamb stud leg; and
a second jamb stud return on an end of said second jamb stud leg; and
at least one L-shaped connector having a pair of legs, one said leg attached to said jamb stud and the other said leg attached to said structure.

38. The jamb stud arrangement of claim 37 wherein said L-shaped connector slidably attaches said jamb stud to said structure.

39. The jamb stud arrangement of claim 37 wherein at least one said L-shaped connector comprises:
a first connector plate attachable to said structure; and
a second connector plate having at least one slot therethrough for receiving a fastener for coupling said second connector plate to said jamb stud.

40. The jamb stud arrangement of claim 39 wherein said second connector plate has at least two slots therein and wherein a first fastener extends through one said slot to engage said first jamb stud leg and wherein another fastener extends through another slot to engage said first jamb stud leg.

41. The jamb stud arrangement of claim 39 wherein said fastener extends through said slot to engage said jamb stud web.

42. The jamb stud arrangement of claim 37 wherein said at least one L-shaped connector comprises:
a first connector comprising:
a first connector plate attachable to said track; and
a second connector plate having a first slot therethrough for receiving a first fastener therethrough that engages said first jamb stud leg and a second slot for receiving a second fastener therethrough to engage said first jamb stud leg; and
a second connector comprising:
a first connector plate for attachment to said track; and
a second connector plate having at least one slot therein for receiving another fastener therethrough which engages said jamb stud web.

43. The jamb stud arrangement of claim 39 wherein said second connector plate has at least two slots therein and wherein a first fastener extends through one said slot to engage said first jamb stud leg and wherein another fastener extends through another slot to engage said second jamb stud leg.

44. A jamb stud arrangement comprising:
a structure;
a track attached to said structure, said track having a web and a pair of flanges;
a jamb stud comprising:
a substantially planar jamb stud web;
a first jamb stud flange protruding from said substantially planar jamb stud web;
a second jamb stud flange protruding from said substantially planar jamb stud web and being spaced from said first jam stud flange;
a first jamb stud leg protruding from said first jamb stud flange and being substantially parallel to said substantially planar jamb stud web;
a second jamb stud leg protruding from said second jamb stud flange and being substantially parallel to said substantially planar jamb stud web;
a first jamb stud return on an end of said first jamb stud leg; and
a second jamb stud return on an end of said second jamb stud leg;
at least one hold-down attached to said jamb stud and said track.

45. The jamb stud arrangement of claim 44 wherein said hold-down comprises:
a strut portion attachable to said jamb stud; and
a base portion attached to said strut portion and said track.

46. The jamb stud arrangement of claim 44 further comprising:
another jamb stud attached to said jamb stud, said another jamb stud comprising:
another substantially planar jamb stud web;
another first jamb stud flange protruding from said another substantially planar jamb stud web;
another second jamb stud flange protruding from said another substantially planar jamb stud web and being spaced from said another first jamb stud flange;
another first jamb stud leg protruding from said another first jamb stud flange and being substantially parallel to said another substantially planar jamb stud web;
another second jamb stud leg protruding from said another second jamb stud flange and being substantially parallel to said another substantially planar jamb stud web;
another first jamb stud return on an end of said another first jamb stud leg; and
another second jamb stud return on an end of said another second jamb stud.

47. A support post comprising:
a post stud comprising:
a substantially planar post stud web;
a first post stud flange protruding from said substantially planar post stud web;
a second post stud flange protruding from said substantially planar post stud web and being spaced from said first post stud flange;
a first post stud leg protruding from said first post stud flange and being substantially parallel to said substantially planar post stud web;
a second post stud leg protruding from said second post stud flange and being substantially parallel to said substantially planar post stud web;
a first post stud return on an end of said first post stud leg; and
a second post stud return on an end of said second post stud leg; and
another post stud comprising:
another substantially planar post stud web, said another substantially planar post stud web attached to said substantially planar post stud web of said post stud;
another first post stud flange protruding from said another substantially planar post stud web;
another second post stud flange protruding from said another substantially planar post stud web and being spaced from said another first post stud flange;
another first post stud leg protruding from said another first post stud flange and being substantially parallel to said another substantially planar post stud web;
another second post stud leg protruding from said another second post stud flange and being substantially parallel to said another substantially planar post stud web;
another first post stud return on an end of said another first post stud leg; and
another second post stud return on an end of said another second post stud leg.

48. The support post of claim 47 further comprising at least one other stud attached to at least one of said post stud and said another post stud.
